(19) United States
(12) Patent Application Publication
(10) Pub. No.: US 2020/0412693 A1
(43) Pub. Date: Dec. 31, 2020

(54) INFORMATION PROCESSING APPARATUS, METHOD AND PROGRAM

(71) Applicant: Evrika Inc., Tokyo (JP)

(72) Inventor: Naoki YAMADA, Tokyo (JP)

(73) Assignee: Evrika Inc., Tokyo (JP)

(21) Appl. No.: 16/909,969

(22) Filed: Jun. 23, 2020

(30) Foreign Application Priority Data
Jun. 27, 2019 (JP) 2019-119373

(51) Int. Cl. H04L 29/06; G06F 9/455; H04L 29/08

(52) U.S. Cl. CPC H04L 63/0209; H04L 67/34; H04L 67/06; G06F 9/455

(57) ABSTRACT

An information processing apparatus that executes inspection with regard to one or more security inspection items includes a plurality of containers which are container-type virtual terminals, where resources including a file system provided by an operating system (OS) of the information processing apparatus are isolated from each other, a data acquisition unit that acquires data flowing over a network before the data reaches a destination, and a data transmission unit that transmits the data to the destination. Part of the plurality of containers is an inspection container where an application for executing the inspection has been implemented. The inspection container includes an inspection unit that executes the inspection with regard to the data that has been acquired.

### CROSS-REFERENCE TO RELATED APPLICATION

This application is based upon and claims the benefit of priority of the prior Japanese Patent Application No. JP2019-119373, filed on Jun. 27, 2019, the entire contents of which are incorporated herein by reference.

### FIELD

The present disclosure relates to a technique to inspect data on a network.

### BACKGROUND

Conventionally, there has been proposed a method including steps of detecting a change for a virtual machine in a virtual server of a virtual network infrastructure, determining whether a virtual security appliance is configured in the virtual server, and sending a request to create the virtual security appliance in the virtual server. The method further includes a step of allowing the virtual machine to initiate when the virtual security appliance is created in the virtual machine. The virtual security appliance performs security inspections on network packets sent from the virtual machine. The method further includes a step of creating an intercept mechanism in the virtual server to intercept network packets from the virtual machine. Further, one or more security policies identify one or more virtual security appliances to process the network packets from the virtual machine (see Japanese Patent Application Publication No. 2016-129043).

There also has conventionally been proposed a physical network security device and a control method thereof, that includes a main virtual machine, a sub-virtual machine, and a physical network card, and executes a step of acquiring each of an operation state of the main virtual machine and the sub-virtual machine, a step of effecting control to switch a binding relation between the virtual machine and the physical network card in a case where occurrence of failure has been detected at the main virtual machine, and a step of effecting control to switch the sub-virtual machine to a new main virtual machine and control to switch the main virtual machine where the failure has occurred to a new sub-virtual machine (see Japanese Patent. Application Publication No. 2017-73763).

### SUMMARY

An example of the present disclosure is an information processing apparatus that executes inspection with regard to one or more security inspection items. The information processing apparatus includes a plurality of containers which are container-type virtual terminals, where resources including a file system provided by an OS of the information processing apparatus are isolated from each other, a data acquisition unit that acquires data flowing over a network before the data reaches a destination, and a data transmission unit that transmits the data to the destination. Part of the plurality of containers is an inspection container where an application for executing the inspection has been implemented. The inspection container includes an inspection unit that executes the inspection with regard to the data that has been acquired.

The present disclosure can be comprehended as an information processing apparatus, system, a method executed by a computer, or a program causing a computer to execute the method.

The present disclosure can also be comprehended as a recording medium from which a computer, other device, a machine or the like can read such a program.

Here the recording medium, which can be read by a computer or the like, is a recording medium which stores such information as data and programs, and so forth by an electrical, magnetic, optical, mechanical or chemical action, and which can be read by a computer or the like.

### BRIEF DESCRIPTION OF THE DRAWINGS

FIG. 1 is a schematic diagram illustrating a configuration of conventional virtualization technology according to an embodiment;

FIG. 2 is a schematic diagram illustrating a configuration of a Linux container according to the embodiment;

FIG. 3 is a schematic diagram illustrating a configuration of a system according to the embodiment;

FIG. 4 is a diagram illustrating a hardware configuration of a communication inspection device according to the embodiment;

FIG. 5 is a diagram illustrating an overview of a functional configuration of a communication inspection device according to the embodiment;

FIG. 6 is a diagram illustrating a configuration of a connection management table according to the embodiment;

FIG. 7 is a diagram illustrating a configuration of a first routing table according to the embodiment;

FIG. 8 is a diagram illustrating a configuration of a second routing table according to the embodiment;

FIG. 9 is a diagram illustrating a configuration of a contract information table according to the embodiment;

FIG. 10 is a diagram illustrating an overview of a functional configuration of a container according to the embodiment;

FIG. 11 is a diagram illustrating a configuration of a container routing table for an IP filter container #2 according to the embodiment;

FIG. 12 is a diagram illustrating a configuration of a container routing table for a mail filter container #1 according to the embodiment;

FIG. 13 is a flowchart A illustrating an overview of a flow of packet processing according to the embodiment;

FIG. 14 is a flowchart B illustrating an overview of a flow of packet processing according to the embodiment;

FIG. 15 is a flowchart C illustrating an overview of a flow of packet processing according to the embodiment;

FIG. 16 is a flowchart A illustrating an overview of a flow of response packet processing according to the embodiment;

FIG. 17 is a flowchart B illustrating an overview of a flow of response packet processing according to the embodiment;

FIG. 18 is a flowchart illustrating an overview of a flow of application updating (updating small-volume module) processing according to the embodiment;

FIG. 19 is a flowchart illustrating an overview of a flow of application updating (updating large-volume module) processing according to the embodiment;

FIG. 20 is a flowchart illustrating an overview of a flow of route setting processing according to the embodiment;

FIG. 21 is a flowchart illustrating an overview of a flow of container switching processing in conjunction with application updating according to the embodiment;

FIG. 22 is a diagram illustrating a configuration of a connection management table according to the embodiment;

FIG. 23 is a diagram illustrating a configuration of a first routing table A according to the embodiment; and

FIG. 24 is a diagram illustrating a configuration of a first routing table B according to the embodiment.

### DESCRIPTION OF EMBODIMENTS

Embodiments of an information processing apparatus, a method, and a program according to the present disclosure will be described below with reference to the drawings.

The following embodiments, however, are examples and are not intended to limit the information processing apparatus, the method and the program according to the present disclosure to the specific configurations described below. In implementation, specific configurations may be employed as appropriate in accordance with the mode of implementation, and various improvements and modifications may be made.

In these embodiments, a case when the information processing apparatus, method, and program according to the present disclosure are applied to a communication inspection device, will be described. Note however, that the information processing apparatus, method, and program according to the present disclosure is capable of being broadly used in technology for inspecting data on a network, and the targets to which the present disclosure can be applied are not limited to the examples shown in these embodiments.

About Container

While Linux (registered trademark) Containers (LXC) is used in the present embodiment as a container-type virtual terminal, Linux Containers is an exemplification of a container-type virtual terminal, and other types of container-type virtual terminals may be employed as appropriate when carrying out the technology according to the present disclosure.

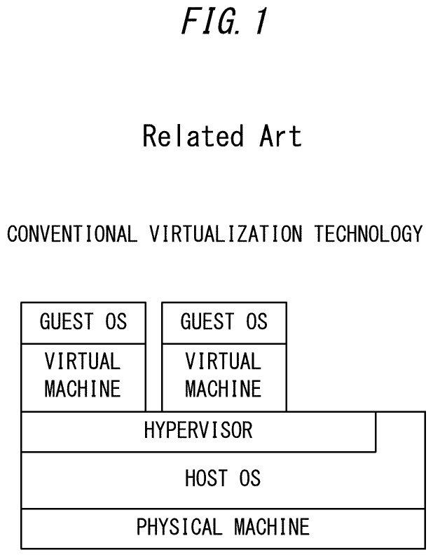

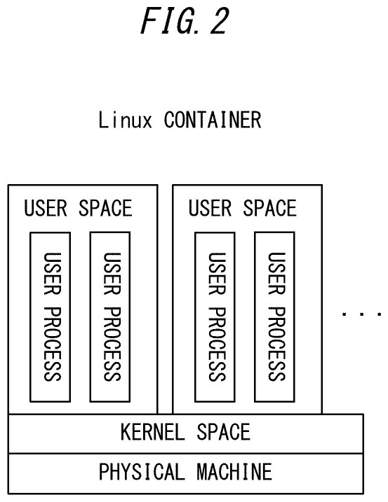

FIG. 1 is a schematic diagram illustrating a configuration of conventional virtualization technology according to the present embodiment. FIG. 2 is a schematic diagram illustrating a configuration of a Linux container according to the present embodiment. Linux Containers is one type of virtualization technology, for constructing an application (user process) execution environment on the OS, isolated from other parts of the system. In conventional server virtualization technology, virtual machines (VM) are created on a host OS or hypervisor (virtualization software). Individual independent guest OSs are executed inside the virtual machines, thereby enabling a plurality of OS environments to be constructed. Specifically, the hypervisor splits the shared resources (CPU, memory, hard disk, etc.) of a physical machine into a plurality, which is then provided to each of the virtual machines, thereby creating a virtual hardware environment. Accordingly, this sort of virtualization technology is also referred to as “hardware virtualization”.

In contrast with this, the OS running on the physical machine may be just the one host OS in Linux Containers. Inside of the host OS is divided into a “kernel space” that manages physical resources, and “user space” where user processes are executed. A plurality of virtual user spaces, called containers, are created in container-type virtualization like Linux Containers, and applications are executed in these isolated spaces. Specifically, computer resources that can be used through the OS are isolated for each container in Linux Containers, which enables a space (OS environment) independent from applications directly operating on the host OS and other containers to be created. Accordingly, this sort of container-type virtualization technology is also referred to as “OS-level virtualization”.

In a container environment, resource management systems called namespaces (name space) and cgroups (control groups), which are functions of the Linux kernel, are used, thereby enabling a plurality of containers within a single OS to run as processes.

The aforementioned namespaces realize a plurality of separated spaces on a single OS, realizing separation of access to processes, file systems, and so forth to realize control such that the processes in the separated spaces are invisible from other separated spaces. Note that all processes, including inside of the containers, can be viewed from an external environment that does not belong to the particular containers. Note that a namespace is not a single function called “namespace”, and that there are a plurality of functions depending on resources (items) to be made independent. Examples of “namespace” include mnt namespace (mount namespace), net namespace (network namespace), and so forth.

An mnt namespace is for separating mount information of a file system visible from a process. Accordingly, each container can have independent file systems and can be made incapable of accessing file systems of different namespaces, through the functions of this mnt namespace. A net namespace is a namespace that performs network control, and each namespace can independently have various types of network resources. Specifically, network devices, IP addresses, routing tables, port Nos., filtering tables, and so forth, can be held independently. Accordingly, the function of this net namespace enables each container to have an individual IP address separate from the host OS, and enables network communication to be performed between a plurality of containers and the host OS.

In Linux Containers, containers are realized by using these functions to create a plurality of spaces where various types of resources are separated. Allocation of hardware resources to each of the separated namespaces, and restriction of usage of the resources, is performed by cgroups. Specifically, cgroups can group processes, and allocate and restrict resources such as CPU, memory, network, and so forth, and combinations thereof, among the processes. This function enables a situation, where a certain container uses up the resources of the host OS and processes and other containers on the host OS are affected, to be avoided.

Containers have several advantages as compared with conventional virtualization technology, due to having the above-described features. For example, startup of a container is only startup of a process as viewed from the OS, and there is no concept of shutdown or booting of a virtual machine as in conventional virtualization technology, so startup and shutdown of virtual environments can be performed quickly. Also, containers do not need virtualization hardware as with conventional virtualization technology, and all that is necessary is to create an isolated space, so there is little overhead due to virtualization. With containers, processes of applications are separated for each container, but are directly executed by the host OS environment, so there is an advantage in that performance equivalent to that of the host OS can be exhibited in CPU usage in a container.

In the container-type virtualization technology according to the present embodiment, making each application independent enables influence on applications in other containers to be suppressed at the time of updating or the like of applications, and accordingly continuity of inspection can be improved as compared with inspection in a conventional communication inspection device. Also, in container-type virtualization technology, shutdown and startup of the virtual environment necessary at the time of updating and so forth of applications can be performed quickly as compared with conventional virtual machines, as described above, and accordingly continuity of inspection can be improved as compared to cases of performing inspection with conventional communication inspection devices or virtual machines. Further, there is no need to stop containers that are running, for long periods of time, due to constructing a plurality of containers for each inspection item (application), performing updating processing regarding applications in containers that are not running, or newly constructing containers that are not running, in which updated applications have been implemented. That is to say, simply switching a container used for a transfer route for data from a currently-running container to a container where updating of an application has been completed enables updating processing of the application in this container used for the transfer route to be completed. Accordingly, there is almost no interruption of inspection due to updating processing of applications, and continuity of inspection can be improved.

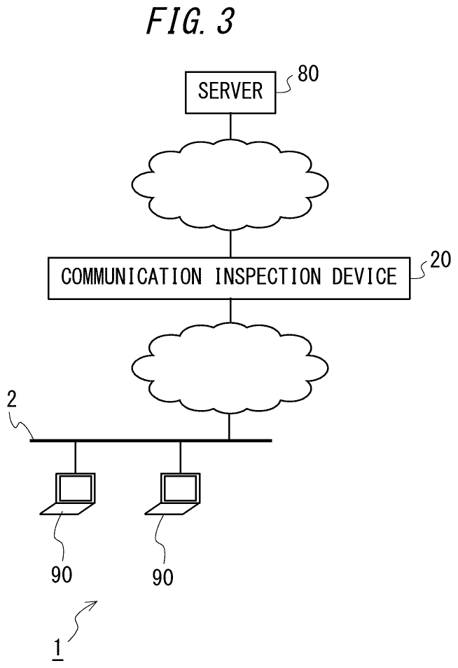

System Configuration FIG. 3 is a schematic diagram illustrating a configuration of a system 1 according to the present embodiment. The system 1 according to the present embodiment is provided with a network segment 2 to which a plurality of user terminals 90 (hereinafter referred to as “client(s) 90”) that are information processing terminals are connected, and a communication inspection device 20 for relaying communication regarding the clients 90. Further, the clients 90 within the network segment 2 are capable of communicating with various servers 80 which are connected at remote areas via the Internet or a wide-area network, through the communication inspection device 20. Note that the client(s) 90 and server(s) 80 are each examples of a “destination” in the present disclosure. In the present embodiment, the communication inspection device 20 is connected between the client(s) 90 and server(s) 80, thereby acquiring data (packets) passing through. Out of the acquired data, the communication inspection device 20 transfers data that is not the object of inspection, and data regarding which determination has been made that transferring is appropriate as a result of inspection.

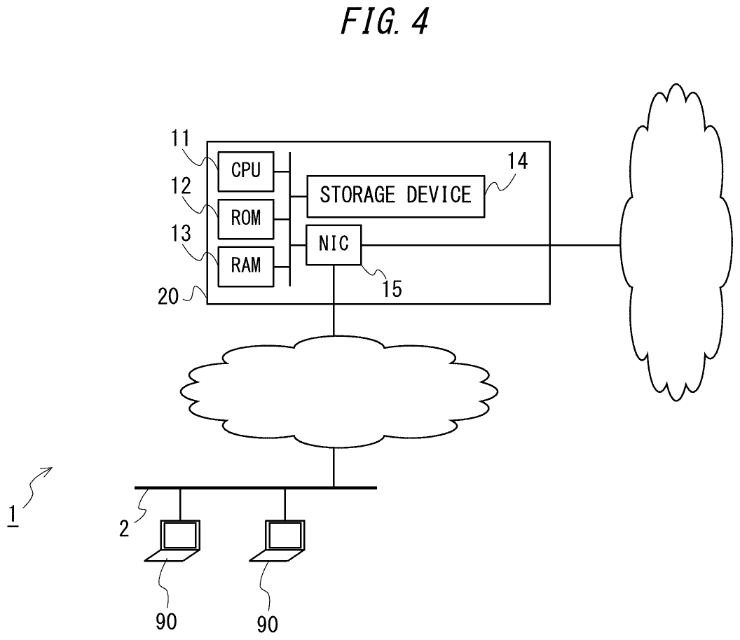

FIG. 4 is a diagram illustrating a hardware configuration of the communication inspection device 20 according to the present embodiment. The communication inspection device 20 is a computer that is provided with a central processing unit (CPU) 11, read-only memory (ROM) 12, random access memory (RAM) 13, a storage device 14 such as electrically erasable and programmable read-only memory (EEPROM), a hard disk drive (HDD), or the like, and a communication unit such as a network interface card (NIC) 15 or the like, and so forth. Note however, that the specific hardware configuration of the communication inspection device 20 may involve omissions, substitutions, and additions, as appropriate in accordance with the mode of implementation. Further, the communication inspection device 20 is not limited to be a single device. The communication inspection device 20 may also be realized by a plurality of devices, using the so-called cloud, distributed computing, or like technology.

Communication Inspection Device

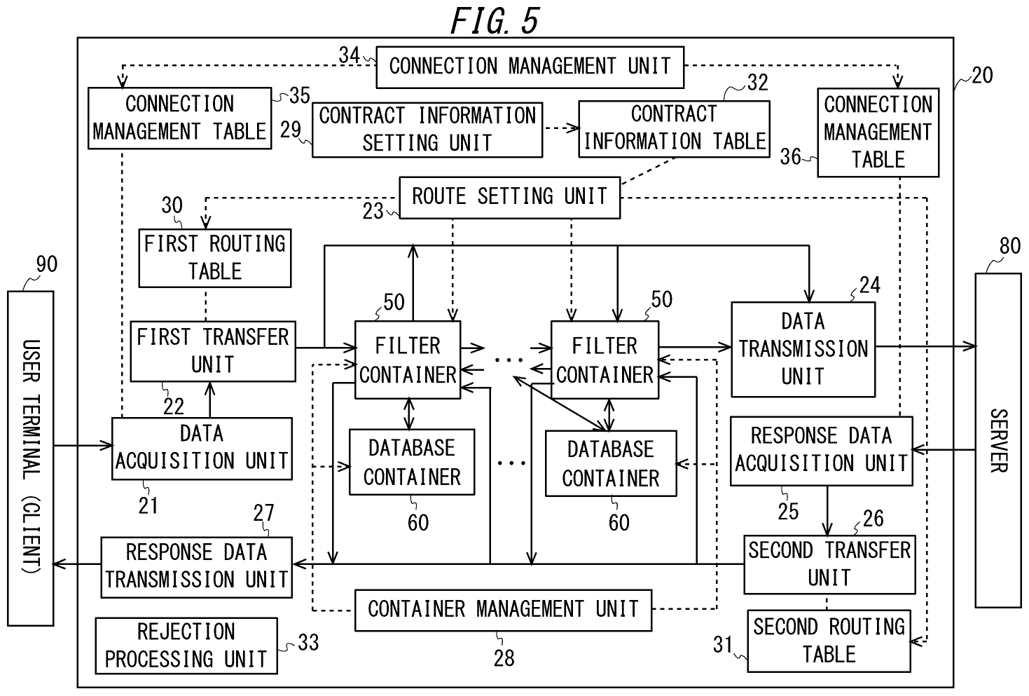

FIG. 5 is a diagram illustrating an overview of a functional configuration of the communication inspection device 20 according to the present embodiment. The communication inspection device 20 functions as an information processing apparatus that is provided with a data acquisition unit 21, a first transfer unit 22, a route setting unit 23, a data transmission unit 24, a response data acquisition unit 25, a second transfer unit 26, a response data transmission unit 27, a container management unit 28, a contract information setting unit 29, a rejection processing unit 33, and a connection management unit 34, by a program recorded in the storage device 14 being loaded to the RAM 13 and executed by the CPU 11. Note that while the functions provided to the communication inspection device 20 are executed by the CPU 11 that is a general-purpose processor in the present embodiment, part or all of these functions may be executed by one or a plurality of dedicated processors. Also, part or all of these functions may be executed by a device installed at a remote area, or a plurality of devices installed in a distributed manner, using cloud technology or the like. Note that the data acquisition unit 21 and first transfer unit 22 may function as a balancer situated on the client. 90 side in the communication inspection device 20, and the response data acquisition unit 25 and second transfer unit 26 may function as an outbound relay situated at the server 80 side in the communication inspection device 20, for example. In the present embodiment, the balancer and outbound relay each have independent IP addresses, but in a case where a balancer and outbound relay are provided to a bridge serving as a relay device, both of the balancer and outbound relay may have a single IP address.

The communication inspection device 20 is provided with one or a plurality of a first routing table 30 and second routing table 31 (each being an example of a “routing table” in the present disclosure), a contract information table 32, and connection management tables 35 and 36. These tables are stored in the storage device 14. The communication inspection device 20 is a Linux server for example, where Linux containers, which are container-type virtual terminals, are created (constructed). Note that one or a plurality of a filter container (inspection container) 50 and a database container 60, which are Linux containers, are created at the communication inspection device 20 in the present embodiment.

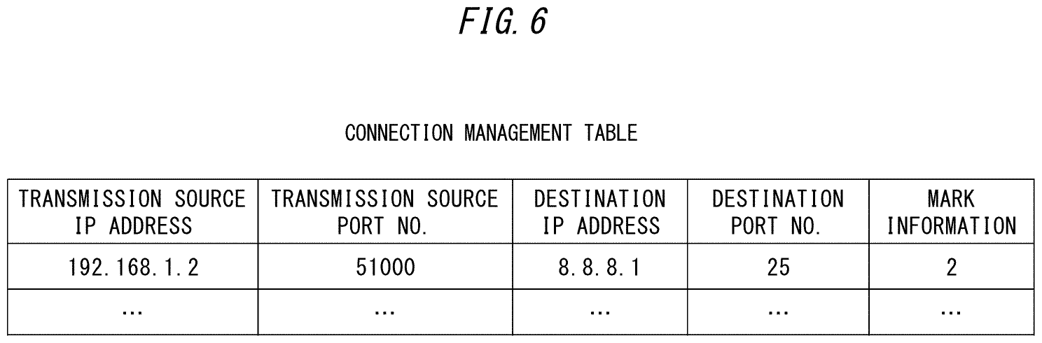

FIG. 6 is a diagram illustrating the configuration of the connection management tables 35 and 36 according to the present embodiment. The connection management tables 35 and 36 are tables for managing connections that are currently connected between the clients 90 and server 80 (existing connections), and hold (store) information identifying existing connections. The columns of the connection management tables 35 and 36 hold the items of transmission source IP addresses, transmission source port Nos., destination IP addresses, destination port Nos., and mark information, as illustrated in FIG. 6. The “transmission source IP address” and “transmission source port No.” is information indicating the address and port No. of the transmission source of data (client 90 or server 80), and “destination IP address” and “destination port No.” is information indicating the address and port No. of the destination of data (client 90 or server 80), in the present embodiment.

The “mark information” column stores a mark designated according to the type (type of services provided by the server 80) of protocol of the data (Transmission Control Protocol/Internet Protocol (TCP/IP) is exemplified). The mark designated according to the type of protocol can be optionally set (defined), such as mark 1 in a case of a protocol relating to Hypertext Transfer Protocol Secure (HTTPS) (case where the server-side port No. is 443 or the like), mark 2 in a case of a protocol relating to mail (case where the server-side port No. is 25, 110, 143, or the like), no mark in a case of any other protocol, and so forth, for example. Also, an arrangement may be made where the mark information stores a mark indicating an existing connection (existing connection mark), which will be described later. Note that the “mark information” is not limited to “mark information” using numerals as described above, and symbols or the like may be used, since it is sufficient as long as which protocol received data relates to can be distinguished by the information.

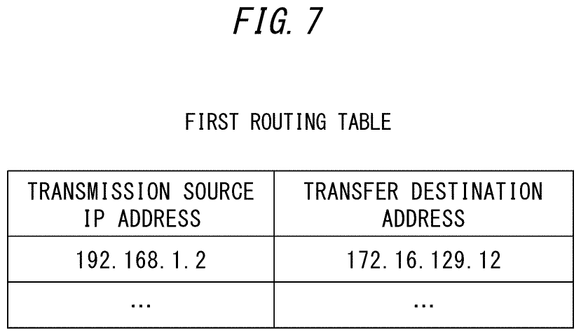

FIG. 7 is a diagram illustrating the configuration of the first routing table 30 according to the present embodiment. The first routing table 30 is a table holding information that is referenced in order to decide the next transfer destination of data received from the client 90 (the transfer destination to which the data should be transferred next). The columns of the first routing table 30 hold the items of transmission source IP addresses and transfer destination addresses, as illustrated in FIG. 7. In the present embodiment, “transmission source IP address” is information indicating the address of the client 90 that is the transmission source of the data, and “transfer destination address” is information indicating the address of the next transfer destination of the data.

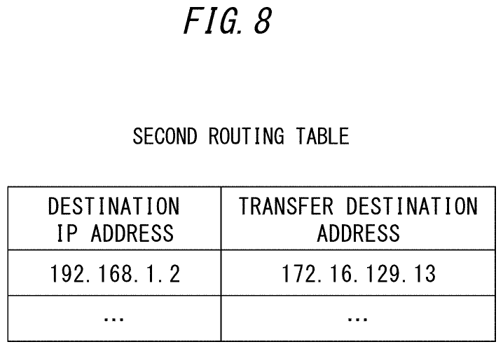

FIG. 8 is a diagram illustrating the configuration of the second routing table 31 according to the present embodiment. The second routing table 31 is a table holding information that is referenced in order to decide the next transfer destination of response data received from the server 90. The columns of the second routing table 31 hold the items of destination IF addresses and transfer destination addresses, as illustrated in FIG. 8. In the present embodiment, “destination IP address” is information indicating the address of the client 90 that is the destination of the response data, and “transfer destination address” is information indicating the address of the next transfer destination of the response data.

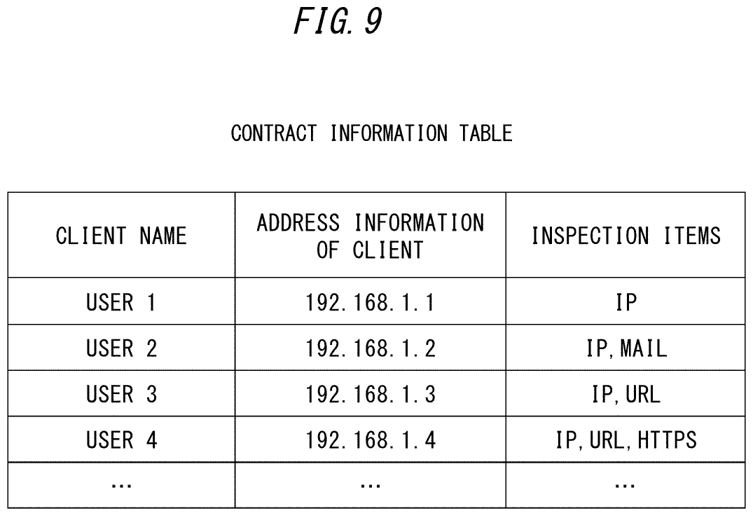

FIG. 9 is a diagram illustrating the configuration of the contract information table 32 according to the present embodiment. The contract information table 32 is a table that holds one or more inspection items (contract information) that clients 90 need in correlation with address information of the clients 90, and that is referenced in order to decide the transfer route of data in order to execute inspections needed by the clients 90. The columns of the contract information table 32 include client names, address information of clients 90, and inspection items (filtering types), as illustrated in FIG. 9. Exemplified under “inspection items” in the present embodiment are IP filtering, mail filtering, URL filtering, and HTTP(S) filtering. Note that items stored in the contract information table 32 are not restricted to the above-described items, and information indicating the type of protocol of data which is the object of this filtering or the like may be included, for example.

The data acquisition unit 21 (an example of “data acquisition unit” in the present disclosure) acquires data flowing over the network before the data reaches the destination. For example, the data acquisition unit 21 acquires data transmitted from a client 90 according to the present embodiment before the data reaches the server 80. Note that in the present embodiment, the communication inspection device 20 can take all communication going through the communication inspection device 20 as the object of inspection, not just communication by clients 90 connected to the network segment 2.

The data acquisition unit 21 also applies marks to the acquired data, designated in accordance with the type of protocol. Specifically, the data acquisition unit 21 references connection information (information for identifying connections) corresponding to the data, which the connection management unit 34 has stored in the connection management table 35, and applies to the data the same mark as the mark stored as this connection information. Note that at this time, the data acquisition unit 21 references the connection management table 35 on the basis of the transmission source IP address, destination IP address, and destination port No. set in the acquired data, and determines that a connection matching this information is a connection corresponding to this data. Note that the data acquisition unit 21 may reference the connection management table 35 on the basis of four kinds of information, where the transmission source port No. has been added to the above three kinds of information, and determine the corresponding connection. Also, the function of applying marks to packets (packet marking function) does not apply marks to packets themselves, but applies marks in data managing packets within the OS, and is only valid in the OS where the marks have been applied. In this way, applying mark information to data, and deciding the transfer destination of this data by referencing this mark information, enable inspection to be performed in accordance with the type of data (type of protocol).

The connection management unit 34 stores connection information regarding data acquired by the data acquisition unit 21 or response data acquisition unit 25 in the connection management tables 35 and 36. Specifically, in a case where a connection regarding acquired data is a connection not stored in the connection management tables 35 and 36 (i.e., is a new connection), the connection management unit 34 stores information identifying this connection (transmission source IP address, transmission source port No., destination IP address, destination port No., and mark) in the connection management tables 35 and 36. Note that the connection management unit 34 determines the protocol of this data by referencing the port No. of the server (the destination port No. or transmission source port No. in the TCP header of the acquired data), and stores a mark corresponding to this protocol in the mark information space in the connection management tables 35 and 36.

The first transfer unit 22 transfers the data that the data acquisition unit 21 has acquired to the filter container 50 or data transmission unit 24, on the basis of a rule set by the route setting unit 23, and the first routing table 30. The first transfer unit 22 references the first routing table 30 specified by the rule, on the basis of the mark information applied to the data acquired by the data acquisition unit 21 and the transmission source IP address in the IP header of this data. Accordingly, the first transfer unit 22 decides the transfer destination (transfer destination address) of the acquired data, and transfers the data to this transfer destination. Note that data that has been judged to not be the object of inspection at the communication inspection device 20 is transferred to the data transmission unit 24 by the first transfer unit 22 without passing through the filter container 50.

The route setting unit 23 decides a transfer route for data passing through the filter container 50 corresponding to each inspection for each client 90 that is the transmission source or destination of data (or for each plurality of clients 90), so as to execute one or more inspections that the client needs. The route setting unit 23 decides the transfer route of data for each client (for each protocol type of each client) on the basis of the contract information table 32. The route setting unit 23 creates and updates the first routing table 30, second routing table 31, and a container routing table 55 that each filter container 50 has, on the basis of the transfer route that has been decided.

Also, the route setting unit 23 sets rules specifying the routing table corresponding to the mark information, so that the routing table to be referenced can be identified on the basis of mark information applied to the data. The route setting unit 23 may also set rules specifying the routing table corresponding to the mark information and client information, so that the routing table to be referenced can be identified on the basis of this mark information and client information. Note that this rule (command data) is stored in the storage device 14 in the same way as the routing table.

Further, the route setting unit 23 sets a filter container 50 where an application updated by an update unit 54 in the filter container 50 has been implemented, or a filter container 50 that has been newly constructed by the container management unit 28 and an application after updating has been implemented, as the filter container to be used as the transfer route of the data.

The data transmission unit 24 (an example of “data transmission unit” in the present disclosure) receives data transmitted from a client 90 from the first transfer unit 22 or filter container 50, and transmits the data to the server 80 that is the destination.

The response data acquisition unit 25 (an example of “data acquisition unit” in the present disclosure) acquires data flowing over the network before the data reaches the destination. For example, the response data acquisition unit 25 acquires response data transmitted from the server 80 according to the present embodiment before the response data reaches the client 90.

The response data acquisition unit 25 also applies a mark, designated by the type of protocol, to the acquired response data. Specifically, the response data acquisition unit 25 references connection information corresponding to this response data, stored in the connection management table 36 by the connection management unit 34, and applies to the response data the same mark as the mark stored as this connection information. Note that at this time, the response data acquisition unit 25 references the connection management table 36 on the basis of the transmission source IP address, transmission source port No., and destination IP address that have been set in the acquired response data, and determines that a connection matching this information is a connection corresponding to this response data. Note that the response data acquisition unit 25 may reference the connection management table 36 on the basis of four kinds of information, where the destination port No. has been added to the above three kinds of information, and determine the corresponding connection. The method of applying marks is the same as the case of the data acquisition unit 21 described above.

The second transfer unit 26 transfers the response data that the response data acquisition unit 25 has acquired to the filter container 50 or the response data transmission unit 27 on the basis of a rule that the route setting unit 23 has set, and the second routing table 31. The second transfer unit 26 references the second routing table 31 specified by the rule, on the basis of the mark information applied to the response data acquired by the response data acquisition unit 25 and the destination IP address in the IP header of this response data. Accordingly, the second transfer unit 26 decides the transfer destination (transfer destination address) of the acquired response data, and transfers the response data to this transfer destination. Note that response data that has been judged by the second transfer unit 26 to not be the object of inspection at the communication inspection device 20 is transferred to the response data transmission unit 27 without passing through the filter container 50.

The response data transmission unit 27 (an example of “data transmission unit” in the present disclosure) receives response data, transmitted from the server 80, from the second transfer unit 26 or filter container 50, and transmits this response data to the client 90.

The container management unit 28 creates a container that is a container-type virtual terminal in response to a request from a manager or the like of the communication inspection device 20, and executes an application in the container. Note that an arrangement may be made where an application is automatically executed within a container. The container management unit 28 also receives, from an application server, an update notification and updating data for an application, due to improvement of functions, correcting trouble, or the like, and performs updating processing of this application. In a case where updating of a small-volume module within the application is necessary, the container management unit 28 transmits a request for the update and updating data to the filter container 50. At this time, the container management unit 28 decides a filter container that is not running out of the plurality of filter containers 50 constructed regarding a security inspection item corresponding to this application (where this application has been implemented), and transmits an update request and so forth to the container that has been decided. In contrast with this, in a case where updating of a large-volume module within the application is necessary, the container management unit 28 newly constructs a filter container where the application regarding the security inspection item relating to updating, after updating, has been implemented, and that is not running, separately from the filter container where the application regarding this security inspection item, before updating, is running, using the received updating data. Note that in the present embodiment, a “filter container that is not running” is a filter container not used for transfer (route) of data.

The contract information setting unit 29 receives address information of a client 90 and contract information indicating one or more inspections that this client 90 needs, and stores these in the contract information table 32 in a correlated manner. In a case of a client 90 that has a fixed IP address, the contract information setting unit 29 receives, from this client 90 or a client 90 that is a manager managing a plurality of the clients 90, an IP address (fixed IP address) regarding the client 90. Also, in a case of a client 90 that has a changeable (dynamic) IP address, the contract information setting unit 29 receives an IP address (changeable IP address) regarding the client. 90 from a virtual private network (VPN) server managing this client 90. Note that although description is made in the present embodiment regarding an arrangement where fixed IP addresses of clients are received from a manager client or the like, and changeable IP addresses of clients are received from a VPN server, this is not restrictive, and another information processing terminal connected to the communication inspection device 20 via the Internet may be used. The contract information setting unit 29 also receives contract information from the client 90 or a client 90 or the like that is a manager managing a plurality of the clients 90. Note that the contract information setting unit 29 may receive information indicating the type of protocol of data that is the object of performing the inspection.

In a case where transfer of data to a destination has been rejected by the filter container 50, the rejection processing unit 33 performs rejection processing regarding data transfer as to the client 90 that is the transmission source or destination of this data. In a case where data transfer has been rejected by IP filtering, for example, the rejection processing unit 33 rejects connection with the client 90 (cuts off the connection). Also, in a case of data transfer having been rejected by mail filtering for example, the rejection processing unit 33 transmits a mail indicating that data transfer to the client 90 is rejected (error mail). Also, in a case where data transfer has been rejected by URL filtering or HTTP(S) filtering for example, the rejection processing unit 33 transmits a message (data) to the client 90, so that this message indicating that transfer is rejected will be displayed on an HTTP or HTTP(S) page.

The filter container 50 is a container that executes security inspection, in which an application for executing security inspection regarding acquired data is implemented. The filter container 50 executes security inspection regarding acquired data, and decides whether or not it is appropriate to permit data transfer to the destination set in this data. In the present embodiment, IP filtering, URL filtering, mail filtering, and HTTP(S) filtering will be exemplified as inspection items of security inspection. It should be noted, however, that specific inspection items and inspection techniques that can be used in inspection according to the present disclosure are not limited to the exemplifications in the present embodiment. Various known and yet to be developed inspection items and inspection techniques may be employed as specific inspection items and inspection techniques.

In the various types of filtering, determination of whether or not it is appropriate to pass acquired data to the destination is performed by matching with filter conditions (inspection conditions), thereby restricting or permitting (filtering) transfer of data to the destination. IP filtering is a function of performing filtering on the basis of header information, such as IP, TCP, UDP, ICMP, and so forth (to control passage and rejection of data). Accordingly, transfer of data of which the destination is a particular IP address can be rejected, for example. URL filtering is filtering of Web sites on the Internet that can be accessed or browsed, and filtering is performed by matching with a list (table) of URLs regarding which access or the like is to be permitted (or rejected). Mail filtering mainly relates to spam filters and virus filters, filtering unwanted mail such as ads (spam mail and unwanted mail), mail infected with a virus, and so forth, out of mails. HTTP(S) filtering is a function of filtering regarding whether or not data regarding HTTP(S) communication contains a virus, and IP filtering and URL filtering can be performed together therewith by application-level analysis. Note that IP filtering and URL filtering is unnecessary for response data, since it is data where content is transmitted in response to a request from a client.

In the present embodiment, a filter container 50 is constructed for each security inspection item. That is to say, each filter container 50 only executes inspection for one inspection item (one application). For example, filter containers are configured such as a container in which is implemented an application for performing IP filtering (IP filter container), a container in which is implemented an application for performing URL filtering (URL filter container), a container in which is implemented an application for performing mail filtering (mail filter container), a container in which is implemented an application for performing HTTP(S) filtering (HTTP(S) filter container), and so forth. Note however, that these are not restrictive, and an arrangement may be made where a plurality of applications are implemented in one filter container, with inspection regarding a plurality of inspection items being executed.

Also, a plurality of filter containers 50 are constructed for each security inspection item in the present embodiment. That is to say, a plurality of filter containers 50 in which the same application is implemented are configured. A plurality of each filter container are configured, such as IP filter container #1, IP filter container #2, mail filter container #1, mail filter container #2, and so on, for example.

The database container 60 is a container that holds a database storing filter conditions regarding security (threat information, etc.), that are considered to be necessary for security inspection (filtering). The database container 60 determines whether or not a portion of the acquired data that is the object of inspection matches filter conditions. In the present embodiment, an IP database, URL database, spam database, and virus database are exemplified as databases storing filter conditions (later-described “filter condition databases”).

In the present embodiment, a database container is constructed for each type of filter condition database. That is to say, each database container is only provided with one type of filter condition database. An IP database container having an IP database, a URL database container having a URL database, a spam database container having a spam database, a virus database container having a virus database, and so on, are configured, for example. Note however, that this is not restrictive, and an arrangement may be made where one database container is provided with a plurality of types of filter condition databases. Also note that a plurality of database containers provided with the same filer condition database may be constructed.

Containers

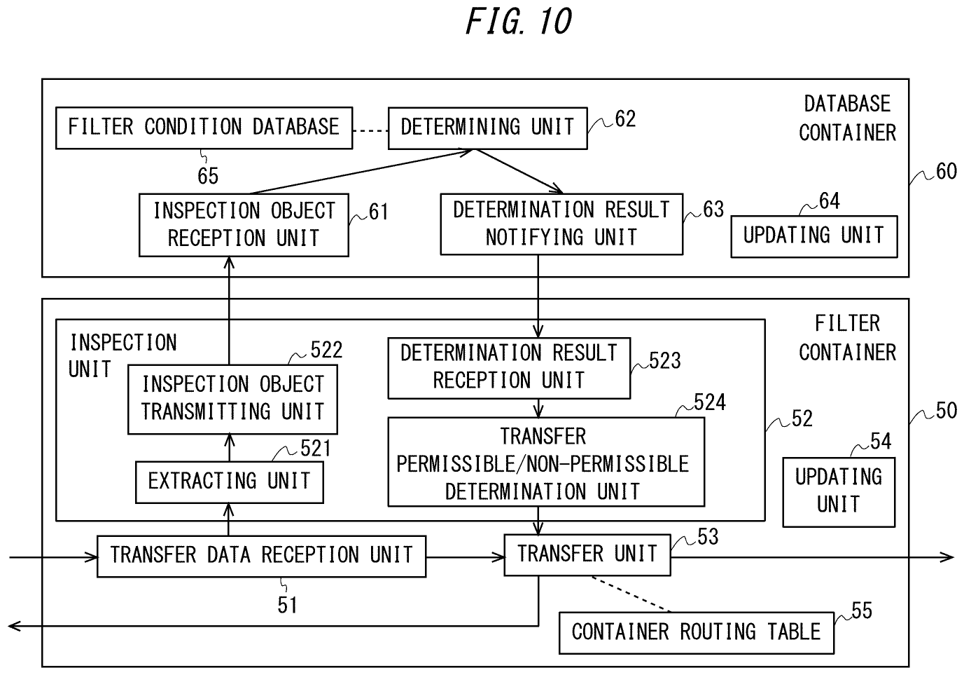

FIG. 10 is a diagram illustrating an overview of a functional configuration of a container according to the present embodiment. The filter container 50 functions as a container provided with a transfer data reception unit 51, an inspection unit 52, a transfer unit 53, and an updating unit 54, by a program recorded in the storage device 14 being loaded to the RAM 13 and executed by the CPU 11. The database container 60 functions as a container provided with an inspection object reception unit 61, a determining unit 62, a determination result notifying unit 63, and an updating unit 64, by a program recorded in the storage device 14 being loaded to the RAM 13 and executed by the CPU 11. Note that while the functions that the filter container 50 and the database container 60 have are executed by the CPU 11 that is a general-purpose processor in the present embodiment, part or all of these functions may be executed by one or a plurality of dedicated processors.

The filter container 50 has a container routing table 55, and the database container 60 has a filter condition database 65, with each being stored in the storage device 14.

Filter Container

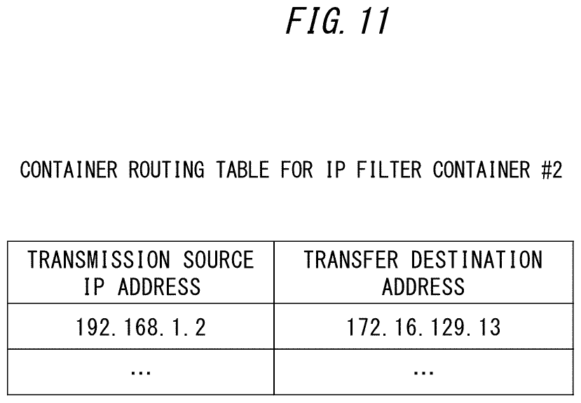

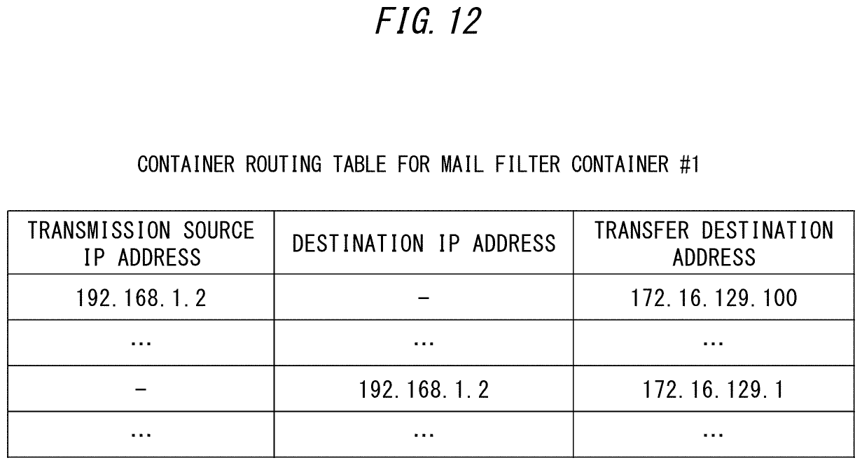

FIG. 11 is a diagram illustrating the configuration of the container routing table 55 of IP filter container #2 according to the present embodiment. FIG. 12 is a diagram illustrating the configuration of the container routing table 55 of mail filter container #1 according to the present embodiment. The container routing tables 55 is a table that holds information referenced in the container for deciding the next transfer destination of data received from a client 90 or server 80. The columns of the container routing table 55 hold items such as transmission source IP addresses, destination IP addresses, transfer destination addresses, and so forth. The “transmission source IP address” in the container routing table 55 is an item referenced in a case of transferring data transmitted from a client 90 to the server 80, and the “destination IP address” in the container routing table 55 is an item referenced in a case of transferring response data transmitted from the server 80 to the client 90. Note that depending on the type of filtering (content of inspection), there are inspections that do not need to be carried out regarding response data (return packets) from the server 80, and the item of “destination IP address” in the container routing table 55 does not need to be provided for filter containers 50 regarding such inspections.

For example, FIGS. 11 and 12 exemplify container routing tables 55 for an IP filter container and a mail filter container. IP filtering does not need to be performed regarding response data from the server 80, so the item “destination IP address” is not provided in the container routing table for the IP filter container. Note that in a case where it is desired to branch the next transfer destination in accordance with the protocol of received data, the container routing tables 55 may include items such as “mark information” and “port No.” in the filter containers 50, in the same way as in the routing tables. Further, while records (data) to be referenced at the time of transferring data from the client 90 and records to be referenced at the time of transferring response data from the server 80 are both included in the same routing table, as illustrated in FIG. 12, these may be stored in separate routing tables from each other in the present embodiment.

The transfer data reception unit 51 receives data transferred from the first transfer unit 22, second transfer unit 26, or another filter container 50.

The inspection unit 52 executes inspection regarding security inspection items on received (acquired) data.

The inspection unit 52 is further provided with an extracting unit 521, an inspection object transmitting unit 522, a determination result reception unit 523, and a transfer permissible/non-permissible determination unit 524.

The extracting unit 521 extracts a part of the acquired data that is the object of inspection, which is a part corresponding to a filtering (inspection) settings item. For example, in a case of an IP filter container, the extracting unit 521 may extract the IP header. Note that in a case of a filter container that requires a plurality of filtering (inspections) as in the case of a mail filter container, the extracting unit 521 extracts the parts that are the object of inspection for each inspection. For example, in the case of a mail filter container, spam filtering and virus filtering are performed, and accordingly the extracting unit 521 extracts the parts that are the object of inspection for each of these inspections from the acquired data.

The inspection object transmitting unit 522 transmits parts of the acquired data that are the object of inspection, which have been extracted by the extracting unit 521 to the database container 60 provided with the filter condition database 65 used for this filtering. Note that in a case of a filter container requiring a plurality of filtering (inspections) as described above, the inspection object transmitting unit 522 transmits the extracted parts that are the object of inspection for each inspection to respective database containers 60 corresponding thereto.

The determination result reception unit 523 receives, from the determination result notifying unit 63 (described later) of the database container 60 that has received the part of the data that is the object of inspection, a result of determination regarding whether or not the part that is the object of inspection has matched the filter conditions. Note that in a case of a filter container requiring a plurality of filtering (inspections) as described above, the determination result reception unit 523 receives the result of determination regarding each inspection from the plurality of database containers 60.

The transfer permissible/non-permissible determination unit 524 determines whether or not transfer to the destination is permissible, on the basis of the result of determination received by the determination result reception unit 523. For example, by receiving a result of determination that the destination IP address of the acquired data matches a filter condition to not allow the data to pass (reject) in IP filtering, the transfer permissible/non-permissible determination unit 524 determines that the acquired data is not to be transferred to the destination. Note that in a case of a filter container requiring a plurality of filtering (inspections) as described above, the transfer permissible/non-permissible determination unit 524 determines whether or not transfer is permissible on the basis of each result of determination transmitted from the plurality of database containers 60. For example, in a case where even one of the plurality of results of determination is a result determined to match a filter condition to not allow the data to pass, the transfer permissible/non-permissible determination unit 524 determines to not allow the acquired data to be transferred.

The transfer unit 53 transfers the data, regarding which transfer to the destination has been permitted by the transfer permissible/non-permissible determination unit 524, to the next transfer destination, by referencing the container routing table 55. The transfer unit 53 references the container routing table 55 on the basis of the transmission source IP address or destination IF address in the IP header of the data received by the transfer data reception unit 51. Accordingly, the transfer unit 53 decides the transfer destination of the data acquired from the client 90 or server 80, and transfers the data to this transfer destination.

The updating unit 54 receives an update request and updating data for an application from the container management unit 28, and updates this application for executing inspection that the filter container 50 is provided with. The updating unit 54 transmits an update-completed notification to the container management unit 28 after updating of the application is complete.

Database Container

The filter condition (inspection condition) database 65 holds filter conditions used to perform inspection regarding security inspection items (filter conditions regarding security). The filter condition database 65 holds filter conditions for permitting or rejecting transfer of data when performing filtering. The filter condition database 65 can hold, as filter conditions, items (parameters) for filtering, specific values and so forth thereof, and filter types for permitting or rejecting passage of data or the like. For example, a filter condition database 65 of an IP database container holds, as a filter condition, a condition to “reject” data transfer in a case where the destination IP address, which is a parameter, is “10.1.1.1”.

The inspection object reception unit 61 receives the part of data that is the object of inspection from the inspection object transmitting unit 522.

The determining unit 62 determines whether or not the part that is the object of inspection in the data acquired by the inspection object reception unit 61 matches a filter condition held in the filter condition database. For example, in a case where the filer condition is that to “reject” data transfer in a case where the destination IP address is “10.1.1.1”, the determining unit 62 of the IP database container determines whether or not the destination IP address included in the part that is the object of inspection in the data acquired by the inspection object reception unit 61 matches this address.

The determination result notifying unit 63 transmits, to the determination result reception unit 523, information of the result of determination made by the determining unit 62 indicating whether or not the part that is the object of inspection in the data has matched a filter condition.

The updating unit 64 updates the filter condition database 65 that the database container 60 has, and an application and the like that manages this filter condition database. The updating unit 64 receives, from the container management unit 28, update requests and updating data for the filter condition database 65 and an application that manages this database, and updates the filter condition database 65 and the application. The updating unit 64 transmits an update-completed notification to the container management unit 28 when the updating processing is complete.

Note that in the present embodiment, an environment provided with applications for performing inspection and an environment provided with databases are separated, by constructing database containers 60 separately from filter containers 50. Accordingly, applications that perform inspection and databases can be made to be independent from each other, and effects on others when updating each is reduced. Note however, the communication inspection device 20 according to the present disclosure is not limited to constructing database containers 60 independently, and an arrangement may be made where filter containers 50 and the communication inspection device 20 (outside of containers) are provided with databases.

Processing Flow

Next, a flow of processing executed by the system 1 according to the present embodiment will be described by way of flowcharts. Note that the specific content of processing and processing procedures shown in the flowcharts described below are examples of carrying out the present disclosure. Specific content of processing and processing procedures may be selected as appropriate in accordance with the mode of implementation of the present disclosure.

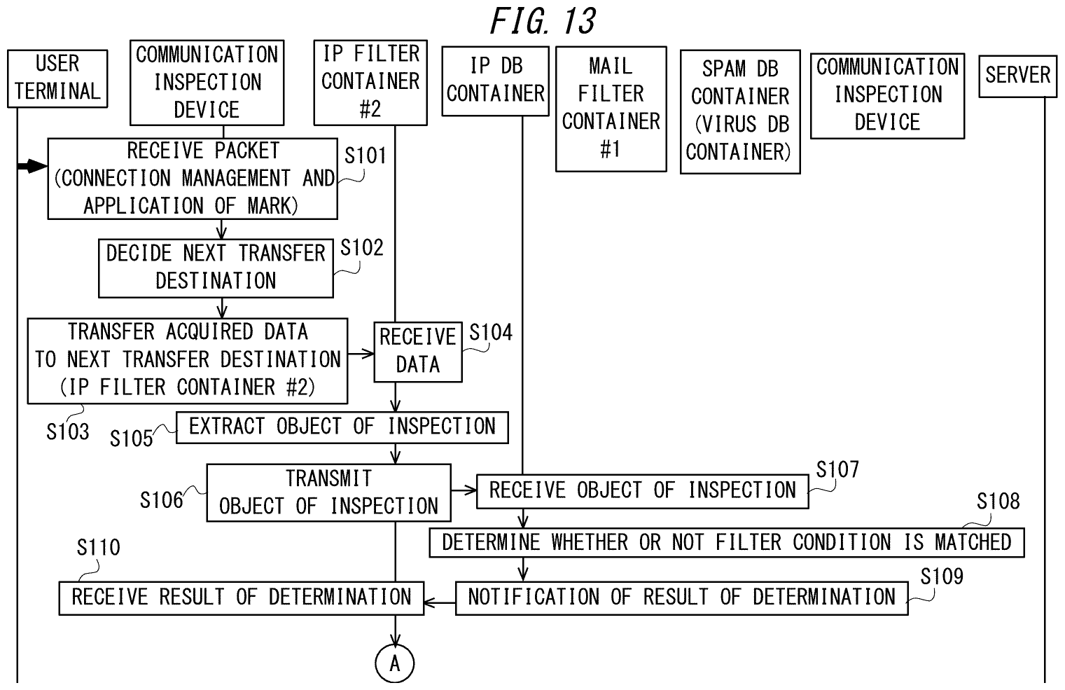

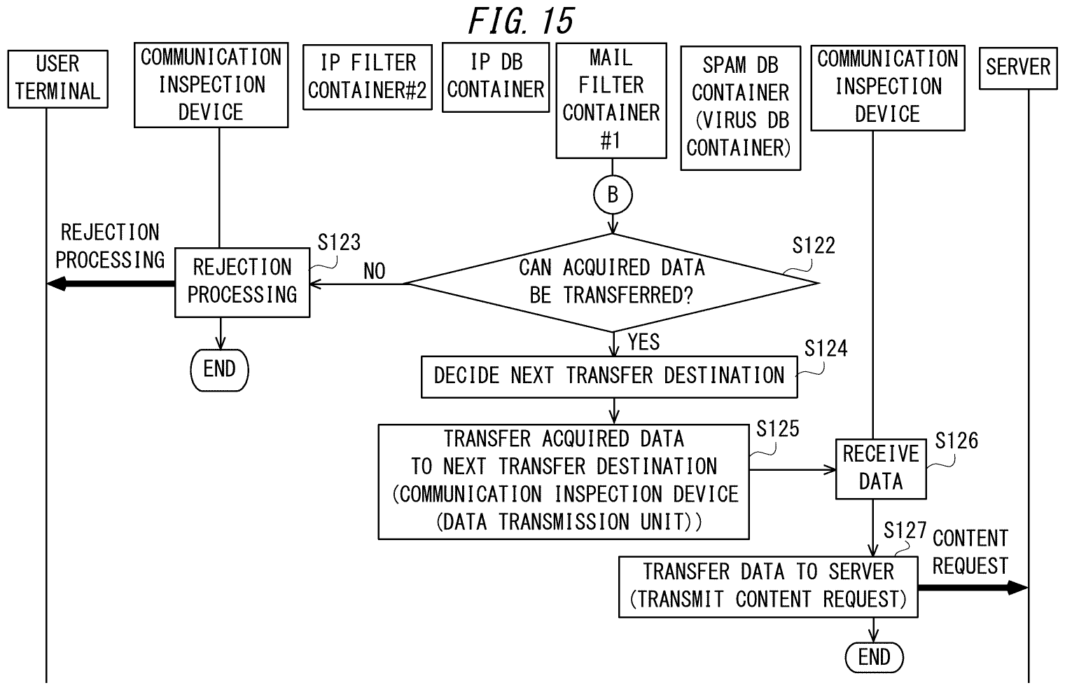

FIG. 13 to FIG. 15 are flowcharts illustrating an overview of the flow of packet processing according to the present embodiment. Processing of a packet relating to mail, from a client 90 (IP address of “192.168.1.2”) that requires inspection of IP filtering and mail filtering, will be exemplified in the present embodiment. The packet processing according to the present embodiment is executed upon being triggered by the communication inspection device 20 receiving a packet (e.g., TCP packet) flowing over a network from the client 90.

In step S101, the packet (data) is received, and management of the connection regarding this packet, and application of a mark to the packet, are performed. Upon the data acquisition unit 21 receiving a packet from the client 90, the connection management unit 34 confirms whether or not the connection regarding the received packet is stored in the connection management table 35. Specifically, the connection management unit 34 confirms whether or not a connection regarding this packet is stored by referencing the connection management table 35 on the basis of the transmission source IP address, transmission source port No., destination IP address, and destination port No., set in the packet.

In a case where the connection regarding this packet is not stored (in a case of a first-time connection), the connection management unit 34 stores connection information regarding this connection in the connection management table 35. At this time, the connection management unit 34 determines the protocol of the received packet by referencing the destination port No. of this packet, and stores mark information corresponding to the type of protocol that has been determined. The data acquisition unit 21 applies, to this packet, the same mark as the mark applied to the connection corresponding to this packet, by referencing the connection management table 35 on the basis of the transmission source IP address, destination IP address, and destination port No. set in the packet. Information regarding the connection of the packet from the client 90 is stored in the present embodiment (see FIG. 6), and at this time a mark “2” is stored as mark information on the basis of on the protocol of this packet (mail-related), and the mark “2” is also applied to the acquired data. Thereafter, the processing advances to step S102.

In step S102, the next transfer destination of the data is decided. The first transfer unit 22 decides that the transfer destination of the data is “172.16.129.12 (IP filter container #2)”, by referencing the first routing table 30 on the basis of the mark information “2” applied to the data acquired in step S101, and the transmission source IP address “192.168.1.2”. Specifically, based on the rule to reference the first routing table #1 (FIG. 7) for the data related to the mark information “2” from the source IP address “192.168.1.2”, set by the route setting unit 23, the first transfer unit 22 decides the next transfer destination of the data, by referencing the first routing table illustrated in FIG. 7. Thereafter, the processing advances to step S103.

In step S103, the data is transferred to the next transfer destination. The first transfer unit 22 transfers the data acquired in step S101 to the transfer destination decided in step S102. The acquired data is transferred to the IP filter container #2 in the present embodiment. Thereafter, the processing advances to step S104.

In step S104, the transferred data is received at the IP filter container #2. The transfer data reception unit 51 receives the data from the client 90 that has been transferred in step S103. Thereafter, the processing advances to step S105.

In step S105, the part of data that is the object of inspection is extracted in the IP filter container #2. The extracting unit 521 extracts the IP header that is the object of IP filtering, for example, from the data received in step S104. Thereafter, the processing advances to step S106.

In step S106, the extracted part that is the object of inspection is transmitted to the IP database container 60. The inspection object transmitting unit 522 transmits the part that is the object of inspection (IP header), extracted in step S105, to the IP database container 60 provided with the filter condition database 65 used for IP filtering. Thereafter, the processing advances to step S107.

In step S107, the part that is the object of inspection is received at the IP database container 60. The inspection object reception unit 61 receives the part that is the object of inspection transmitted in step S106. Thereafter, the processing advances to step S108.

In step S108, whether or not the part that is the object of inspection matches the filter condition is determined in the IP database container 60. The determining unit 62 determines whether or not the part that is the object of inspection received in step S107 matches the filter condition held in the filter condition database 65. Thereafter, the processing advances to step S109.

In step S109, notification (transmission) of the result of determination is made to the IP filter container #2. The determination result notifying unit 63 transmits the result of determination determined in step S108 to the IP filter container #2. Thereafter, the processing advances to step S110.

In step S110, the result of determination is received at the IP filter container #2. The determination result reception unit 523 receives the result of determination transmitted in step S109. Thereafter, the processing advances to step S111.

In step S111, whether or not transfer of data to the destination is permissible is determined at the IP filter container #2 on the basis of the result of determination. In a case where the transfer permissible/non-permissible determination unit 524 determines that transfer of the data transmitted from the client 90 to the destination is not permissible on the basis of the result of determination received in step S110, a rejection notification indicating rejection of data transfer is transmitted to the communication inspection device 20, and the processing advances to step S112. Conversely, in a case where the transfer permissible/non-permissible determination unit 524 determines that transfer of the data transmitted from the client 90 to the destination is permissible, the processing advances to step S113.

In step S112, rejection processing is performed regarding transfer of data. In the present embodiment, the rejection processing unit 33 cuts off communication (connection) with the client 90. Thereafter, the processing illustrated in this flowchart ends.

In step S113, the next transfer destination is decided for the data regarding which transfer to the destination has been permitted. The transfer unit 53 decides the transfer destination of this data to be “172.16.129.13 (mail filter container #1)”, by referencing the container routing table 55 on the basis of the transmission source IP address “192.168.1.2” of the data acquired in step S104. Thereafter, the processing advances to step S114.

In step S114, the data is transferred to the next transfer destination. The transfer unit 53 transfers the data acquired in step S104 to the transfer destination decided in step S113. In the present embodiment, the transfer unit 53 at the IP filter container #2 transfers the acquired data to the mail filter container #1. Thereafter, the processing advances to step S115.

In step S115, the data transferred from the IP filter container #2 is received at the mail filter container #1. The transfer data reception unit 51 receives the data from the client 90 that has been transferred in step S114. Thereafter, the processing advances to step S116.

In step S116, the part of the data that is the object of inspection is extracted at the mail filter container #1. The extracting unit 521 extracts the parts that are the object of inspection for each of spam filtering and virus filtering, which are mail filtering, from the data received in step S115, for example. Note that settings may be made where, in a case where the protocol of data received from the client 90 is a mail transmission protocol, mail filtering (spam filtering and virus filtering) in steps S116 to S123 is performed, and in a case of a mail reception protocol, this mail filtering is not performed since the received data is data regarding a mail reception request. Thereafter, the processing advances to step S117.

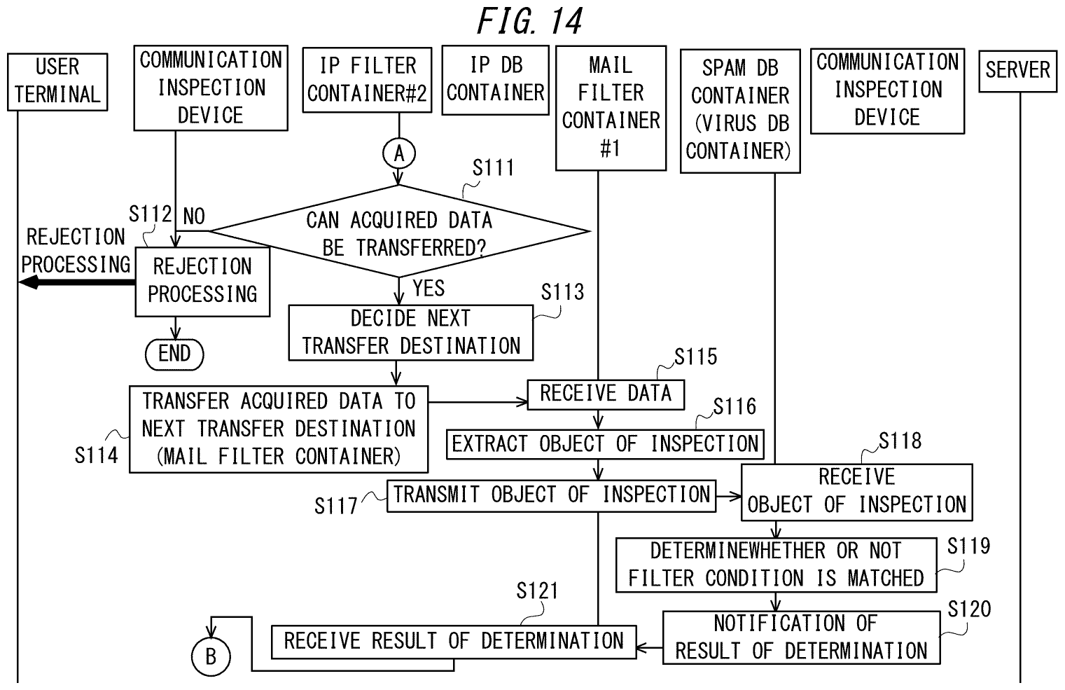

In step S117, the extracted parts that are the object of inspection are each transmitted to a spam database container and a virus database container. The inspection object transmitting unit 522 transmits the parts that are the object of inspection with regard to each of spam filtering and virus filtering, extracted in step S116, to a spam database container and virus database container having the filter condition database 65 used for mail filtering. Thereafter, the processing advances to step S118. Note that while FIG. 14 only shows data processing performed between the mail filter container and spam database container in steps S117 to S121, similar processing is performed between the mail filter container and virus database container in steps S117 to S121 as well. The data processing performed between the mail filter container and virus database container is the same processing as that in steps S117 to S121, and accordingly description will be omitted.

In step S118, the part that is the object of inspection is received at the spam database container 60. The inspection object reception unit 61 receives the part that is the object of inspection, transmitted in step S117. Thereafter, the processing advances to step S119.

In step S119, determination is made at the spam database container 60 regarding whether or not the part that is the object of inspection matches the filter condition. The determining unit 62 determines whether or not the part that is the object of inspection received in step S118 matches the filter condition held in the filter condition database 65. Thereafter, the processing advances to step S120.

In step S120, notification (transmission) of the result of determination is made to the mail filter container 11. The determination result notifying unit 63 transmits the result of determination determined in step S119 to the mail filter container #1. Thereafter, the processing advances to step S121.

In step S121, the result of determination is received at the mail filter container #1. The determination result reception unit 523 receives the result of determination transmitted in step S120. Thereafter, the processing advances to step S122.

In step S122, whether or not data transfer to the destination is permissible is determined at the mail filter container #1 on the basis of the result of determination. In a case where the transfer permissible/non-permissible determination unit 524 determines that transfer of the data transmitted from the client 90 to the destination is not permissible on the basis of the result of determination received in step S121, a rejection notification indicating rejection of data transfer is transmitted to the communication inspection device 20, and the processing advances to step S123. Conversely, in a case where the transfer permissible/non-permissible determination unit 524 determines that transfer of the data transmitted from the client 90 to the destination is permissible, the processing advances to step S124.

In step S123, rejection processing regarding transfer of data is performed. In the present embodiment, the rejection processing unit 33 transmits a mail to the client 90 indicating that data transfer is rejected. Thereafter, the processing illustrated in this flowchart ends.

In step S124, the next transfer destination of the data regarding which transfer to the destination has been permitted is decided. The transfer unit 53 decides the transfer destination of this data to be “172.16.129.100 (communication inspection device (data transmission unit 24))” by referencing the container routing table 55 on the basis of the transmission source IP address “1920.1680.1.2” of the data acquired in step S115. Thereafter, the processing advances to step S125.

In step S125, the data is transferred to the next transfer destination. The transfer unit 53 transfers the data acquired in step S115 to the transfer destination decided in step S124. In the present embodiment, the transfer unit 53 transfers the acquired data to the data transmission unit 24. Thereafter, the processing advances to step S126.

In step S126, data transferred from the mail filter container #1 is received. The data transmission unit 24 receives the data from the client 90 that was transferred in step S125. Thereafter, the processing advances to step S127.

In step S127, the data is transferred to the destination. The data transmission unit 24 transfers the data received in step S126 to the server 80, which is the destination. Thereafter the processing illustrated in this flowchart ends. According to the above-described method, out of the data from the client 90, only data regarding which all inspections that the client 90 requires have been completed and determined to be permissible to transfer in these inspections can be transmitted to the server 80.

Also, according to the above-described method, the applications can be made to be independent, and effects at the time of updating applications on applications in other containers and applications in the communication inspection device (outside of containers) and so forth can be suppressed. Accordingly, continuity of inspection can be improved as compared to inspections in conventional communication inspection devices. Also, performing inspection in container-type virtual terminals enables shutdown and startup of virtual environments necessary at the time of updating applications and so forth to be performed quickly in comparison with conventional virtual machines. Accordingly, continuity of inspection can be improved as compared with a case where inspection is performed in a conventional communication inspection device or virtual machine.

Although a case has been exemplified by way of FIG. 13 to FIG. 15 where the inspection items (contract information) that the client 90 requires are IP filtering and mail filtering, inspection is executed at filter containers through which the data is routed with regard to other contract situations (other filtering combinations) as well, in the same way. For example, all data (IP packets) received from a user 1 are transferred via an IP filter container, as illustrated in the first record (user 1, IP) in the contract information table 32 in FIG. 9. Also, all data (IP packets) received from a user 3 are transferred via an IP filter container, and thereafter data related to HTTP and so forth out of this data is further transferred to a URL filter container, as illustrated in the third record (user 3, IP and URL) in the contract information table 32 in FIG. 9. Also, data related to HTTPS out of data (IP packets) received from a user 4 are transferred to an HTTPS filter container, and other data is transferred to an IP filter container, as illustrated in the fourth record (user 4, IP and URL and HTTPS) in the contract information table 32 in FIG. 9.

Also, an arrangement may be made where, as in the present embodiment, data from the same client is transferred to different filter containers as transfer destinations in accordance with the type of protocol of the data. For example, an arrangement may be made where data regarding mail that is received from the user 2 is transferred to the IP filter container #2, and data other than that regarding mail that is received from the user 2 is transferred to the IP filter container #1. Although description has been made in the present embodiment that a plurality of clients 90 use the same filter containers and database containers, this is not restrictive, and an arrangement may be made where the communication inspection device 20 is provided with filter containers and database containers dedicated to a client 90 or dedicated to a group made up of a plurality of clients 90.

Further, in the present embodiment, mark information corresponding to the type of protocol of a received packet is applied to the packet, the routing table to be referenced regarding the packet is decided on the basis of this mark information and a rule, thereby deciding the next transfer destination of the packet. Accordingly, no protocol information (port No., mark information, etc.) is stored in routing tables and container routing tables. However, embodiments of the present disclosure are not limited to this, and as another embodiment, an arrangement may be made where mark information corresponding to the type of protocol is not applied to the received packet, and protocol information is stored in routing tables and container routing tables, with the next transfer destination of the packet being decided by matching protocol information in these routing tables with the destination port No. or the like of the packet. Further, as another embodiment, an arrangement may be made where mark information corresponding to the type of protocol is applied to the received packet in the same way as in the present embodiment, but no rules are set, and mark information is stored in routing tables and container routing tables, with the next transfer destination being decided by matching mark information in these routing tables with the mark information applied to the packet.

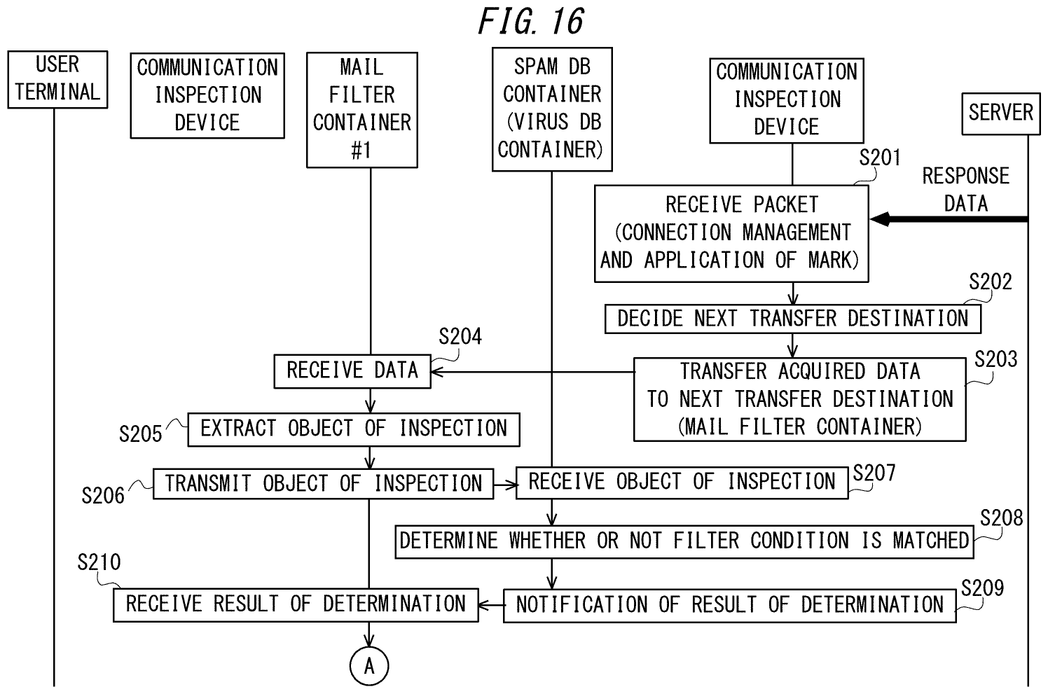

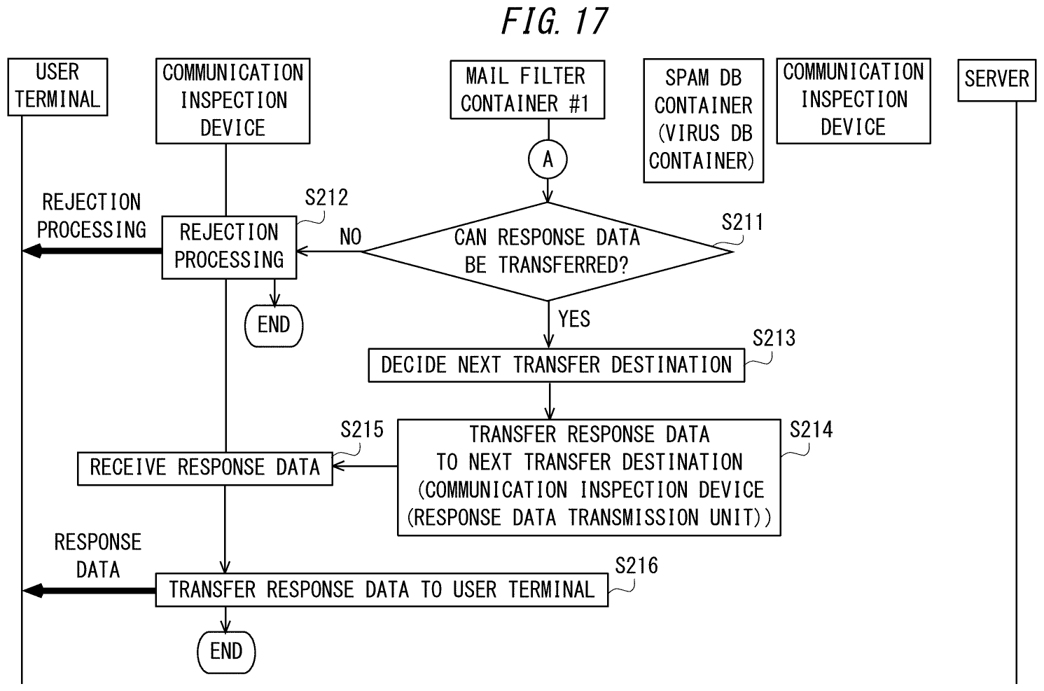

FIGS. 16 and 17 are flowcharts illustrating an overview of the flow of response packet processing according to the present embodiment. Processing of response data (response packet) from the server 80, made as to data regarding mail from a client 90 (IP address of “192.168.1.2”) that requires inspection of IP filtering and mail filtering, will be exemplified in the present embodiment. The packet processing according to the present embodiment is executed upon being triggered by the communication inspection device 20 receiving a response packet flowing over the network from the server 80.

In step S201, the response packet is received, and management of the connection regarding this packet, and application of a mark to the packet, are performed. Upon the response data acquisition unit 25 receiving a response packet from the server 80 bound for the client 90, the connection management unit 34 confirms whether or not the connection regarding the received packet is stored in the connection management table 36. In a case where the connection regarding this packet is not stored (in a case of a first-time connection), the connection management unit 34 stores connection information regarding this connection in the connection management table 36. At this time, the connection management unit 34 determines the protocol of the received packet by referencing the transmission source port No. of this packet, and stores mark information corresponding to the type of protocol that has been determined. The response data acquisition unit 25 applies, to this packet, the same mark as the mark applied to the connection corresponding to this packet, by referencing the connection management table 36 on the basis of the transmission source IP address, transmission source port No., and destination IP address set in the packet. Information regarding the connection relating to the packet from the server 80 is stored in the present embodiment, and at this time a mark “2” is stored as mark information based on the protocol of this packet (mail-related), and the mark “2” is also applied to the acquired data. Thereafter, the processing advances to step S202.

In step S202, the next transfer destination of the data is decided. The second transfer unit 26 decides that the transfer destination of the response data is “172.16.129.13 (mail filter container #1)” by referencing the second routing table 31, on the basis of the mark information “2” applied to the response data acquired in step S201, and the destination IP address “192.168.1.2”. Specifically, based on the rule to reference the second routing table #1 (FIG. 8) for the data related to the mark information “2” and the destination IP address “192.168.1.2”, set by the route setting unit 23, the second transfer unit 26 decides the next transfer destination of the data, by referencing the second routing table illustrated in FIG. 8. Thereafter, the processing advances to step S203.

In step S203, the response data is transferred to the next transfer destination. The second transfer unit 26 transfers the data acquired in step S201 to the transfer destination decided in step S202. The acquired data is transferred to the mail filter container #1 in the present embodiment. Thereafter, the processing advances to step S204.

In step S204, the transferred data is received at the mail filter container #1. The transfer data reception unit 51 receives the response data from the server 80 that has been transferred in step S203. Thereafter, the processing advances to step S205.

In step S205, the part of data that is the object of inspection is extracted in the mail filter container #1. The extracting unit 521 extracts the parts that are the object of inspection for each of spam filtering and virus filtering, which are mail filtering, from the data received in step S204, for example. Note that settings may be made wherein, in a case where the protocol of the response data received from the server 80 is a mail reception protocol, mail filtering (spam filtering and virus filtering) in steps S205 to S212 is performed, and in a case of a mail transmission protocol, this mail filtering is not performed since this response data is response data regarding mail transmission data. Thereafter, the processing advances to step S206.

In step S206, the extracted parts that are the object of inspection are each transmitted to a spam database container and a virus database container. The inspection object transmitting unit 522 transmits the parts that are the object of inspection with regard to each of spam filtering and virus filtering, extracted in step S205, to a spam database container and virus database container having the filter condition database 65 used for mail filtering. Thereafter, the processing advances to step S207. Note that while FIG. 16 only shows data processing performed between the mail filter container and spam database container in steps S206 to S210, similar processing is performed between the mail filter container and virus database container in steps S206 to S210 as well. The data processing performed between the mail filter container and virus database container is the same processing as that in steps S206 to S210, and accordingly description will be omitted.

In step S207, the part that is the object of inspection is received at the spam database container 60. The inspection object reception unit 61 receives the part that is the object of inspection, transmitted in step S206. Thereafter, the processing advances to step S208.

In step S208, determination is made at the spam database container 60 regarding whether or not the part that is the object of inspection matches the filter condition. The determining unit 62 determines whether or not the part that is the object of inspection received in step S207 matches the filter condition held in the filter condition database 65. Thereafter, the processing advances to step S209.

In step S209, notification (transmission) of the result of determination is made to the mail filter container #1. The determination result notifying unit 63 transmits the result of determination determined in step S208 to the mail filter container #1. Thereafter, the processing advances to step S210.

In step S210, the result of determination is received at the mail filter container #1. The determination result reception unit 523 receives the result of determination transmitted in step S209. Thereafter, the processing advances to step S211.

In step S211, whether or not data transfer to the destination is permissible is determined at the mail filter container #1 on the basis of the result of determination. In a case where the transfer permissible/non-permissible determination unit 524 determines that transfer of the response data transmitted from the server 80 to the client 90 is not permissible on the basis of the result of determination received in step S210, a rejection notification indicating rejection of data transfer is transmitted to the communication inspection device 20, and the processing advances to step S212. Conversely, in a case where the transfer permissible/non-permissible determination unit 524 determines that transfer of the response data transmitted from the server 80 to the client 90 is permissible, the processing advances to step S213.

In step S212, rejection processing regarding transfer of data is performed. In the present embodiment, the rejection processing unit 33 transmits a mail to the client 90 indicating that data transfer is rejected. Thereafter, the processing illustrated in this flowchart ends.

In step S213, the next transfer destination of the response data regarding which transfer to the client 90 has been permitted is decided. The transfer unit 53 decides the transfer destination of this response data to be “172.16.129.1 (communication inspection device (response data transmission unit 27))” by referencing the container routing table 55 on the basis of the destination IP address “192.168.1.2” of the response data acquired in step S204. Thereafter, the processing advances to step S214.

In step S214, the response data is transferred to the next transfer destination. The transfer unit 53 transfers the response data acquired in step S204 to the transfer destination decided in step S213. In the present embodiment, the transfer unit 53 transfers the acquired response data to the response data transmission unit 27. Thereafter, the processing advances to step S215.

In step S215, data transferred from the mail filter container #1 is received. The response data transmission unit 27 receives the response data from the server 80 that was transferred in step S214. Thereafter, the processing advances to step S216.

In step S216, the response data is transferred to the client 90. The response data transmission unit 27 transfers the data received in step S215 to the client 90. Thereafter, the processing illustrated in this flowchart ends. According to the above-described method, out of the response data as to data from the client 90, only response data regarding which all inspections that the client 90 requires have been completed and determined to be permissible to transfer in these inspections can be transmitted to the client 90.

Although a case has been exemplified by way of FIGS. 16 and 17 where the inspection items (contract information) that the client 90 requires are IP filtering and mail filtering, inspection is executed at filter containers through which the data is routed with regard to other contract situations as well, in the same way. For example, response data related to HTTPS out of response data (IP packets) as to a content request from user 4 is transferred to an HTTPS filter container, and inspection is executed on the basis of a virus database or the like, as illustrated in the fourth record (user 4, IP and URL and HTTPS) in the contract information table 32 in FIG. 9.

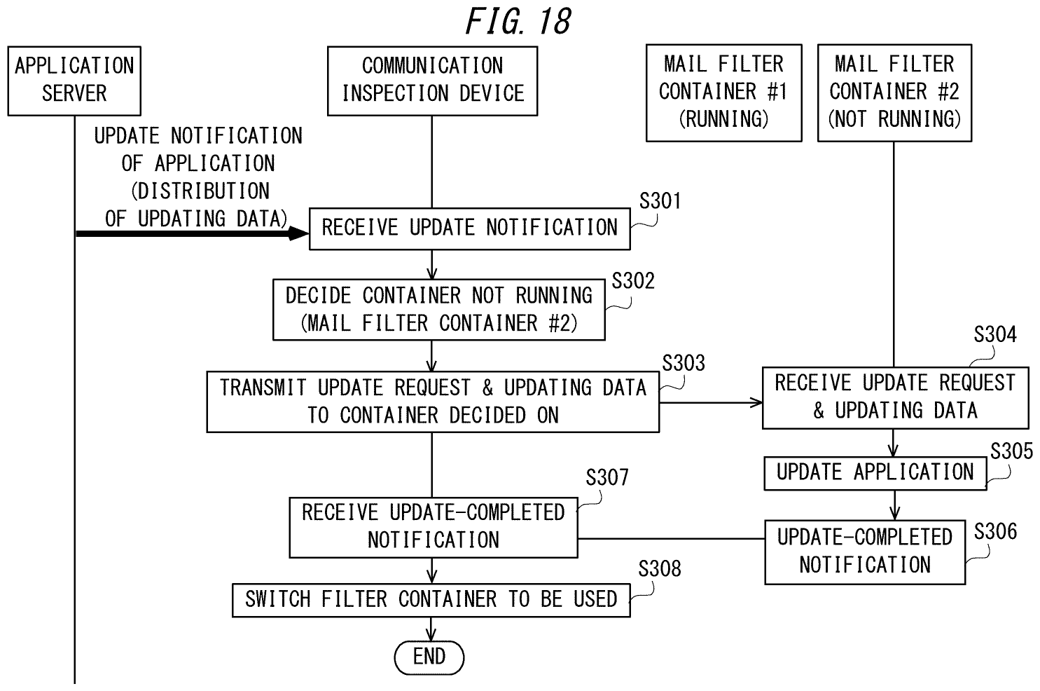

FIG. 18 is a flowchart illustrating an overview of a flow of application updating (updating small-volume module) processing according to the present embodiment. A case where updating processing regarding small-volume module within an application relating to mail filtering is necessary will be exemplified in the present embodiment. The packet processing according to the present embodiment is executed upon being triggered by the communication inspection device 20 receiving an application update notification and updating data from an application server relating to mail filtering.

In step S301, the update notification and updating data are received. The container management unit 28 receives, from the application server, the update notification and updating data regarding updating of the application (small-volume module) relating to mail filtering. Thereafter, the processing advances to step S302.

In step S302, a container that is not running is decided. The container management unit 28 decides, out of a plurality of mail filter containers where the application regarding the update notification received in step S301 is implemented, a container that is not running (mail filer container #2). The container management unit 28 may decide a container that is not running, by extracting a mail filter container that has not been set by the route setting unit 23 in the routing tables 30 and 31 and the container routing table 55 to be used as a transfer route of data, for example. Thereafter, the processing advances to step S303.

In step S303, an update request and updating data are transmitted to the filter container 50. The container management unit 28 transmits the update notification and updating data received in step S301 to the mail filter container #2 that is a filter container which is not running, decided in step S302. Thereafter, the processing advances to step S304.

In step S304, the update request and updating data are received at the mail filter container #2. The updating unit 54 receives the update request and updating data transmitted in step S303. Thereafter, the processing advances to step S305.

In step S305, the application is updated at the mail filter container #2. The updating unit 54 updates the application relating to mail filtering by using the updating data received in step S304. In a case where startup and shutdown of filter containers is necessary in conjunction with this updating processing, startup and shutdown processing may be performed along with the updating of the application. Thereafter, the processing advances to step S306.

In step S306, an update-completed notification of the application is transmitted. The updating unit 54 makes an update-completed notification to the communication inspection device 20 after the updating processing of the application relating to the mail filtering is completed. Thereafter, the processing advances to step S307.

In step S307, the update-completed notification of the application is received at the communication inspection device 20. The container management unit 28 receives the update-completed notification transmitted in step S306. Thereafter, the processing advances to step S308.

In step S308, the filter container of which updating of the application has been completed is set as a filter container used for data transfer (route). The route setting unit 23 updates the routing tables and container routing table, thereby switching the mail filter container used for data transfer from the mail filter container #1 that is running to the mail filter container #2 regarding which updating of the application has been completed. Thereafter, the processing illustrated in this flowchart ends.

In this way, in a case where updating regarding a small-volume module in an application is necessary, updating processing of the application is performed in a filter container 50 that is not running where the application has been implemented, in accordance with an update request from the communication inspection device 20.

According to the method described above, updating processing of applications in containers used for a transfer route can be completed simply by switching the container used in the transfer route for data from a currently-running container to a container where the application after updating has been implemented, and there is no need to shut down the currently-running container for a long time at the time of updating the application. In other words, rebooting of a virtual terminal or the like in conjunction with updating of the application becomes unnecessary, and accordingly the downtime of this application is markedly reduced, and continuity of inspection can be improved.

Although updating processing of an application at a filter container 50 has been exemplified in FIG. 18, updating processing at a database container 60 is also performed by the same flow as in the case of the filter container.

Specifically, the updating unit 64 that the database container 60 is provided with receives update requests and updating data regarding the filter condition database 65 and an application that manages this database from the container management unit 28, and thereby updates the filter condition database 65 and the application.

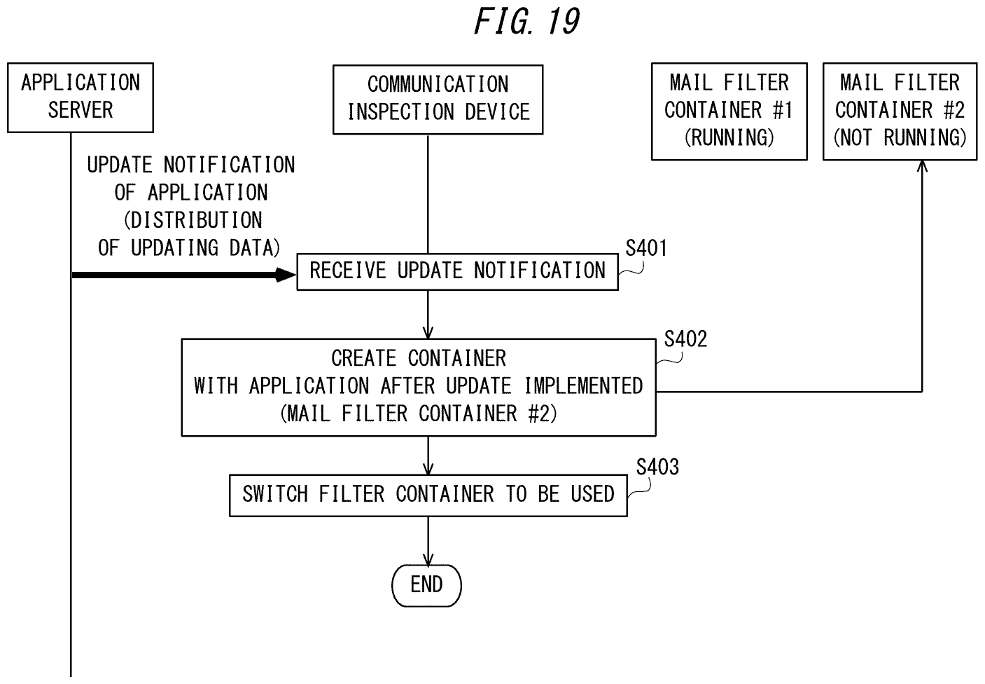

FIG. 19 is a flowchart illustrating an overview of a flow of application updating (updating large-volume module) processing according to the present embodiment. A case where updating processing regarding a large-volume module within an application relating to mail filtering is necessary will be exemplified in the present embodiment. The packet processing according to the present embodiment is executed upon being triggered by the communication inspection device 20 receiving an application update notification and updating data from an application server relating to mail filtering.

In step S401, the update notification and updating data are received. The container management unit 28 receives, from the application server, the update notification and updating data regarding updating of the application (large-volume module) relating to mail filtering. Thereafter, the processing advances to step S402.

In step S402, a filter container in which the application after updating has been implemented is newly constructed (created). In the present embodiment, the container management unit 28 uses the updating data received in step S401 to newly construct a mail filter container #2 where the application after updating is implemented, separately from the mail filter container #1 where the application before updating is running. Thereafter, the processing advances to step S403.

In step S403, the filter container of which updating of the application has been completed is set as a filter container used for data transfer (route). The route setting unit 23 updates the routing tables and container routing table, thereby switching the mail filter container used for data transfer from the mail filter container #1 that is running to the mail filter container #2 regarding which updating of the application has been completed. Thereafter, the processing illustrated in this flowchart ends.

In this way, in a case where updating of a large-volume module in an application is necessary, a filter container that is not running and in which the application after updating is implemented is newly constructed in the communication inspection device 20, regarding security inspection item corresponding to the application.

According to the method described above, rebooting of a virtual terminal or the like in conjunction with updating of the application becomes unnecessary, in the same way as with the case of updating a small-volume module in the application, and accordingly the downtime of this application is markedly reduced, and continuity of inspection can be improved.

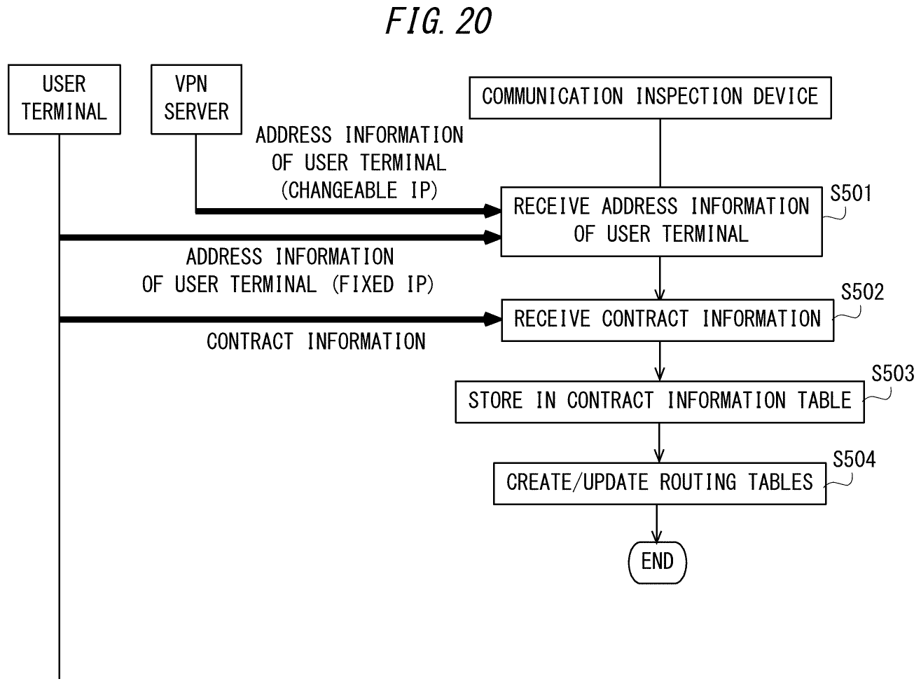

FIG. 20 is a flowchart illustrating an overview of a flow of route setting processing according to the present embodiment. This route setting processing is performed as preparatory processing before inspection is carried out by the communication inspection device 20. In a case where there are changes to the items of the contract information table 32, route setting (changing of transfer route) is performed as appropriate. The route setting processing in the present embodiment is executed upon being triggered by address information of a client being received from a client 90 or the like that is a manager, a VPN server, or the like.

In step S501, address information of a client 90 is received. The contract information setting unit 29 receives an IP address regarding a client 90 that has a fixed IF address, for example, from the client 90 or from a client 90 that is a manager managing the client 90. In the present embodiment, the IP address “192.168.1.2” regarding a user 2 is received, for example. Thereafter, the processing advances to step S502.

In step S502, contract information (inspection items that the client requires) is received. The contract information setting unit 29 receives the contract information from the client 90 or from a client 90 that is a manager managing the plurality of clients 90, or the like. In the present embodiment, information of “user 2 requires inspection items ‘IP (filtering) and mail (filtering)’”, which is contract information regarding the user 2, is received, for example.

Note that the order of steps S501 and S502 is irrelevant, and that an arrangement may be made where the contract information setting unit 29 acquires address information of the client 90 after the contract information setting unit 29 acquires contract information of the client 90. Further, an arrangement may be made where the contract information setting unit 29 acquires address information and contract information of the client 90 at the same time. Thereafter, the processing advances to step S503.

In step S503, the address information and contract information of the client 90 is held. The contract information setting unit 29 stores the address information of the client 90 acquired in step S501 and the contract information of the client 90 acquired in step S502 in the contract information table 32 in a correlated manner. In the present embodiment, address information “192.168.1.2” and contract information “perform IP (filtering) and mail (filtering)” regarding the user 2, for example, are correlated and stored in the contract information table 32. Thereafter, the processing advances to step S504.

The each routing table is created or updated in step S504. The route setting unit 23 decides transfer routes for the data on the basis of the contract information table 32, and creates or updates rules specifying routing tables to be referenced (first routing table and second routing table), and the first routing table 30, second routing table 31, and container routing table 55. In the present embodiment, the route setting unit 23, for example, decides the transfer route so that data regarding mail from the user 2 and correlating response data is transferred in the order of communication inspection device (first transfer unit 22), IP filter container #2, mail filter container #1, communication inspection device (data transmission unit 24), communication inspection device (second transfer unit 26), mail filter container #1, and communication inspection device (response data transmission unit 27), on the basis of a second record “user 2, IP address ‘192.168.1.2’, and inspection items ‘IP (filtering) and mail (filtering)’” in the contract information table 32 in FIG. 9. The route setting unit 23 then creates or updates the rules, and the first routing table 30, second routing table 31, and container routing table 55, as exemplified in FIGS. 7, 8, 11, and 12, so that data regarding mail received from the user 2 is transferred by this transfer route. Thereafter, the processing illustrated in this flowchart ends.

According to the method described above, a transfer route through containers corresponding to inspection required by a client 90 can be decided so that the inspection can be executed for data received from the client 90.

Note that an arrangement may be made where logs are collected from filter containers and database containers in the communication inspection device 20 and other information processing apparatus. For example, logs may be collected from filter containers regarding what sort of inspection was performed and what sort of inspection results were acquired for each client, and the logs may be provided to the clients and so forth. Also, information of threats on a network may be collected from database containers and used for comprehending trends of threats on the network, and so forth, for example.

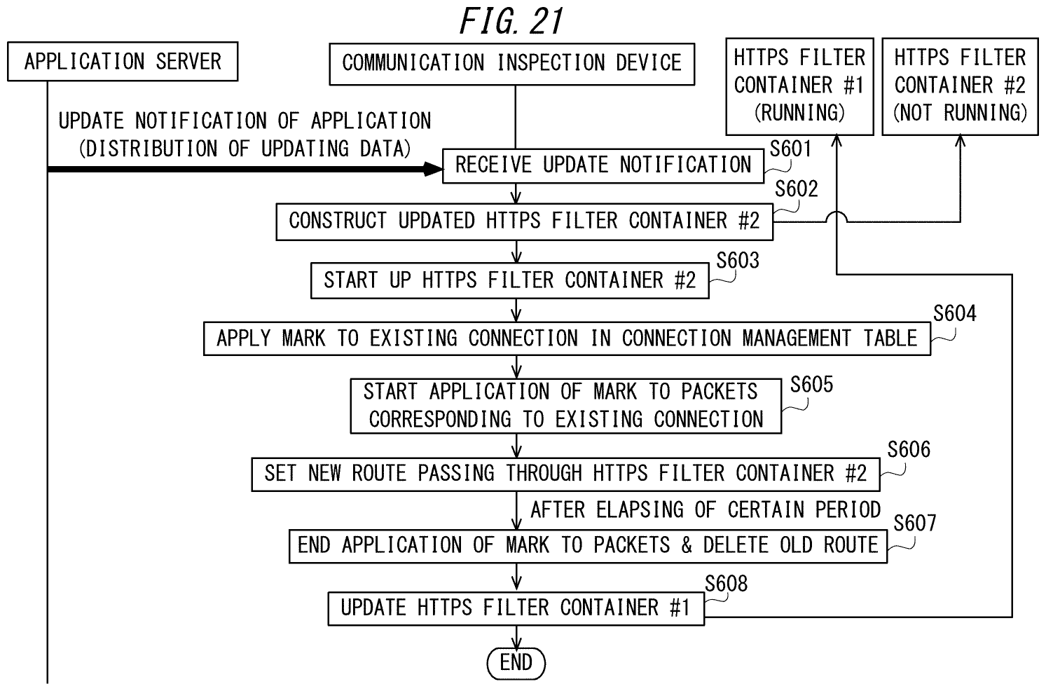

FIG. 21 is a flowchart illustrating an overview of a flow of container switching processing in conjunction with application updating according to the present embodiment. In FIGS. 18 and 19, in conjunction with updating of an application, filter containers used for transfer routes of data are switched en bloc from currently-running filter containers where the application before updating is implemented (old containers) to filter containers where the application after updating is implemented (new containers). In a case where data is transmitted divided into a plurality of packets, or in a case where outbound packets and return packets (response data) pass through the same filter container for confirmation of consistency in communication (in relation to HTTP, HTTPS, etc.) or the like, there is a possibility that connection will be cut off due to filter containers being switched over en bloc as described above. FIG. 21 exemplifies container switchover processing that prevents occurrence of cutoff due to filter container switchover in conjunction with such updating of an application.

Specifically, at the time of updating an application, switching of filter containers implementing the application is not performed for a predetermined amount of time for established connections (existing connections), and currently-running old containers are continued to be used. After a predetermined amount of time has elapsed, the route is switched to a new route passing through the new container in which the updated application has been implemented.

In the present embodiment, a case where updating processing of an application relating to HTTPS filtering is necessary will be exemplified. The packet processing according to the present embodiment is executed upon being triggered by the communication inspection device 20 receiving an application update notification and updating data from an application server relating to HTTPS filtering.

In step S601, an update notification and updating data are received. The container management unit 28 receives the update notification and updating data with regard to updating to the application relating to HTTPS filtering from the application server. Thereafter, the processing advances to step S602.

In step S602, an HTTPS filter container #2 where the application has been updated is constructed. Specifically, processing the same as in steps S302 to S307 in FIG. 18 (updating small-volume module) or step S402 in FIG. 19 (updating large-volume module) is performed. In the present embodiment, an HTTPS filter container #1 is the currently-running container, and the not-running HTTPS filter container #2 where updating of the application has been completed is constructed. Thereafter, the processing advances to step S603.

In step S603, the filter container where updating of the application has been completed is started up. The container management unit 28 starts up the HTTPS filter container #2 where updating of the application has been completed. Thereafter, the processing advances to step S604.

In step S604, a mark indicating an existing connection (existing connection mark) is applied to existing connections stored in the connection management tables 35 and 36. The connection management unit 34 decides (determines) connections stored in the connection management tables 35 and 36 at the point of connection confirmation, i.e., connections connected between the client 90 and server 80 at that point, to be existing connections. The connection management unit 34 then applies an existing connection mark in the spaces for mark information in the connection management tables 35 and 36, for each existing connection. Note that the existing connection mark may be optionally set so as to be a different mark from marks set according to types of protocols, such as “9” or “10” or the like, for example.

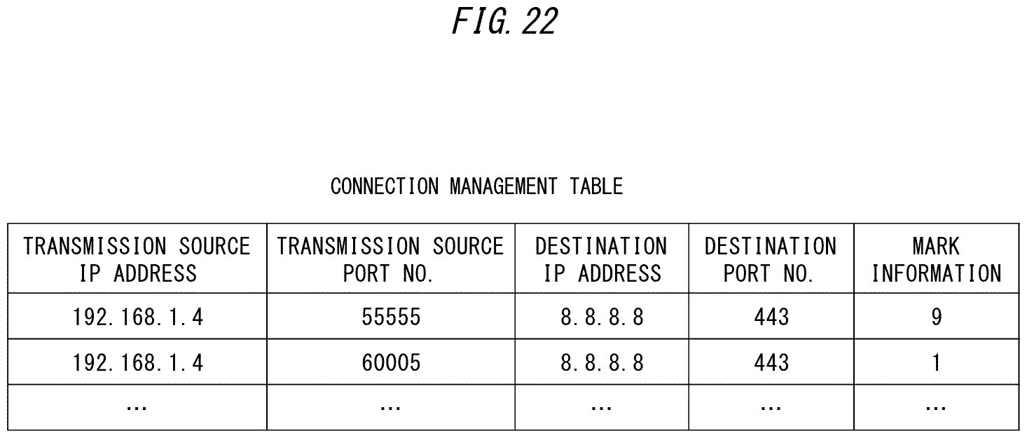

FIG. 22 is a diagram illustrating the configuration of a connection management table according to the present embodiment. As illustrated in FIG. 22, the connection management table according to the present embodiment stores a connection between a user 4 (transmission source IP address of “192.168.1.4” and transmission source port No. of “55555”) and a server (destination IP address of “8.8.8.8” and destination port No. of “443”) as an existing connection A. The connection management unit 34 decides that this connection is an existing connection, and applies an existing connection mark “9” in the corresponding record (mark information space) in the connection management table. Note that this connection had been determined to be an HTTPS-related connection on the basis of the destination port No. “443” before the existing connection mark was applied, and a mark “1” had been applied, for example.

Note that for connections newly established after the existing connection mark is applied to the connection management table, application of a mark is performed by the same method as the processing of step S101 in FIG. 13. Specifically, a connection newly established after connection confirmation is applied with mark information on the basis of protocol as usual (e.g., “1”), as exemplified in the second record in the connection management table in FIG. 22. The second record in FIG. 22 is information of a connection stored at the time of the connection being newly established between the same user and server as the existing connection A with the same protocol (a connection where only the transmission source port No. differs). Thereafter, the processing advances to step S605.

In step S605, application of existing connection marks to reception packets corresponding to existing connections is started. In a case where a received packet corresponds to an existing connection (passes through the existing connection), the communication inspection device 20 applies the existing connection mark applied in step S604 to this received packet. For example, in a case where the combination of the transmission source IP address, transmission source port No., destination IP address, and destination port No. of the received packet matches the combination thereof in an existing connection, an existing connection mark is applied to this packet. In the present embodiment, the data acquisition unit 21 in the communication inspection device 20 applies existing connection marks to packets received from the clients 90, and the response data acquisition unit 25 in the communication inspection device 20 applies existing connection marks to response packets received from the server 80, by making reference to the connection management tables 35 and 36. Note that application of the existing connection marks is performed using the packet mark function described above. Thereafter, the processing advances to step S606.

In step S606, a new route passing through HTTPS filter container #2 where updating of the application has been completed is set as the switching destination route of the existing connection (old route) passing through the HTTPS filter container #1. In the present embodiment, the route setting unit 23 sets a new route where the HTTPS filter container used for passing through on the old route is HTTPS filter container #2 (IP address of “172.16.129.22”), separately from the old route passing through the HTTPS filter container #1 (IP address of “172.16.129.21”). Specifically, the route setting unit 23 creates routing tables and container routing table in which a new route where a new container is the transfer destination has been set, at balancers, outbound relays, and filter containers, which transfer data to the old container situated before and after the old container in which the application to be updated is implemented, separately from the routing tables and container routing table where the old route is set. In the present embodiment, routing tables (first routing table and second routing table) where the new route is set are newly created at the balancers and outbound relays situated before and after the HTTPS filter container #1.

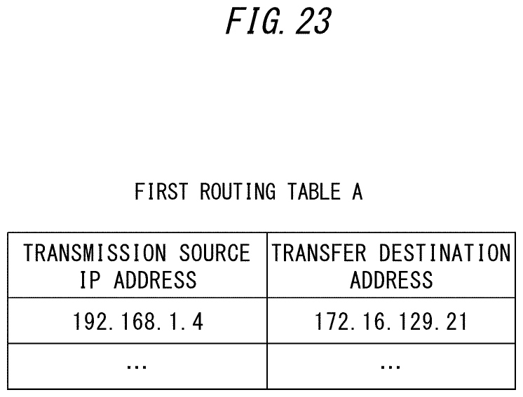

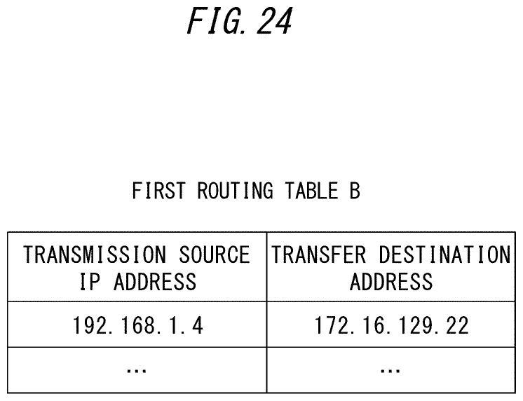

FIGS. 23 and 24 are diagrams illustrating the configuration of the first routing table according to the present embodiment. FIG. 23 is a first routing table A where the old route that passes through the HTTPS filter container #1 (IP address of “172.16.129.21”) is set, and FIG. 24 is a first routing table B where the new route that passes through the HTTPS filter container #2 (IP address of “172.16.129.22”), where updating of the application has been completed, is set. In step S606, the first routing table B is created separately from the first routing table A, for example. In the same way, with regard to the second routing table, a second routing table where the new route is newly set is also created.

Also in step S606, the route setting unit 23 sets a rule to reference the routing table where the new route has been set with regard to packets to which an existing connection mark has not been applied, and to reference the routing table where the old route is set with regard to packets to which an existing connection mark has been applied. For example, in the present embodiment, a rule is set that the first routing table B is referenced for packets not applied with the existing connection mark “9”, and that the first routing table A is referenced for packets applied with the existing connection mark “9”. Note that the order of step S603 and steps S604 to S606 is irrelevant, and the HTTPS filter container #2 may be started up after existing connection marks are applied to the connection management table and received packet. Thereafter, the processing advances to step S607.

In step S607, applying of existing connection marks to received packets that was started in step S605 ends, and the old route is deleted from the routing tables and container routing table. After a predetermined period (amount of time) after execution of step S606, the data acquisition unit 21 and response data acquisition unit 25 end applying of existing connection marks to received packets. The route setting unit 23 also deletes the old route where the old container is the transfer destination from the routing tables at the balancers, outbound relays, and filter containers situated before and after the old container where the application regarding updating is implemented. Further, an arrangement may be made where a rule set to reference a routing table in which the old route is set, with regard to packets applied with an existing connection mark, is deleted.

Note that for existing connections that do not pass through a filter container where the application regarding updating is implemented, the existing connection mark in the mark information space is deleted and mark information based on the protocol type is applied in step S607, instead of deleting the old route from the routing tables. Accordingly, the existing connection can continue to be used even after ending application of existing connection marks to packets.

Thus, by performing the processing of step S607 after a predetermined amount of time elapses from after step S606, it can be anticipated that all existing connections (or a greater part of existing connections) will end during this period, i.e., connections using old containers will end, and thus, a situation where existing connections are cut off due to switching containers can be prevented. Note that a time interval (time lag) may occur between ending application of marks to received packets and deletion of old routes. Further, an arrangement may be made where a routing table where an old route is set (e.g., first routing table A) is deleted, instead of deleting the old route from the routing table. Thereafter, the processing advances to step S608.

In step S608, the HTTPS filter container #1, where the application before updating is implemented, is updated. Specifically, processing the same as that in steps S303 to S307 in FIG. 18 is performed. Thereafter, the processing illustrated in this flowchart ends.

Note that while existing connection marks are applied to all connections stored in the connection management table in step S604 in the present embodiment, this is not restrictive, and an arrangement may be made where existing connection marks are applied only to connections where filter container switching would cause the connection to be cut off. Also, while description has been made that the routing tables and container routing table where the new route is set are newly created in step S606, this is not restrictive, and the new route may be added to the existing routing tables and container routing table.

What is claimed is:

1. An information processing apparatus that executes inspection with regard to one or more security inspection items, the information processing apparatus comprising:
a plurality of containers which are container-type virtual terminals, where resources including a file system provided by an operating system of the information processing apparatus are isolated from each other;
a data acquisition unit that acquires data flowing over a network before the data reaches a destination; and
a data transmission unit that transmits the data to the destination, wherein
part of the plurality of containers is an inspection container where an application for executing the inspection has been implemented; and
the inspection container includes an inspection unit that executes the inspection with regard to the data that has been acquired.

2. The information processing apparatus according to claim 1, wherein
the inspection container is constructed for each of the security inspection items.

3. The information processing apparatus according to claim 2, further comprising:
A route setting unit that decides a transfer route for the data to be transferred to the data transmission unit through an inspection container corresponding to each inspection, such that one or more inspections necessary for the data are executed, wherein,
in conjunction with updating of the application, the route setting unit sets an inspection container which is not running and in which the application after updating has been implemented, constructed separately from an inspection container being used on the transfer route and in which the application before updating has been implemented, as an inspection container to be used on the transfer route of the data.

4. The information processing apparatus according to claim 3, further comprising:
a container management unit that performs updating processing with regard to the application, wherein
a plurality of the inspection containers are constructed for each of the security inspection items; and
when updating the application, the container management unit transmits an update request for the application to an inspection container that is not running, out of the plurality of inspection containers constructed for the security inspection item corresponding to the application.

5. The information processing apparatus according to claim 3, wherein
each of the plurality of containers is a virtual terminal, where network resources provided by the operating system of the information processing apparatus are isolated from each other,
and wherein the inspection container that is not running is an inspection container not being used on the transfer route of the data.

6. The information processing apparatus according to claim 4, wherein
the inspection container further includes an updating unit that receives the update request and updates the application,
and wherein the route setting unit sets the inspection container in which the application updated by the updating unit has been implemented as the inspection container to be used on the transfer route of the data.

7. The information processing apparatus according to claim 3, further comprising:
A container management unit that, when updating the application, newly constructs the inspection container that is not running and in which the application after updating has been implemented, separately from the inspection container being used on the transfer route and in which the application before updating has been implemented.

8. The information processing apparatus according to claim 7, wherein
each of the plurality of containers is a virtual terminal, where network resources provided by the operating system of the information processing apparatus are isolated from each other;
the inspection container that is not running is an inspection container not being used on the transfer route of the data; and
the route setting unit sets the inspection container in which the application after updating has been implemented as the inspection container to be used on the transfer route of the data.

9. The information processing apparatus according to claim 3, wherein,
with regard to the data relating to an already-established connection when updating the application, the route setting unit sets the transfer route to continue to use the existing transfer route passing through the inspection container where the application before updating has been implemented and which is in use in the already-established connection, for a certain period.

10. The information processing apparatus according to claim 1, wherein
the plurality of containers further include a database container provided with an inspection condition database, where an inspection condition regarding security is stored;
the database container includes a determination unit that determines whether or not a part of data that is an object of inspection matches the inspection condition, and
the inspection unit executes the inspection by commissioning the database container to perform determination by the determination unit.

11. The information processing apparatus according to claim 10, wherein
the inspection unit determines whether or not transfer to the destination is permissible, on the basis of a result of determination by the determination unit.

12. The information processing apparatus according to claim 2, further comprising:
a route setting unit that decides, for each user terminal that is a transmission source or destination of the data, a transfer route for the data to be transferred to the data transmission unit through the inspection container corresponding to each inspection, such that one or more inspections necessary for the user terminal are executed.

13. The information processing apparatus according to claim 12, further comprising:
a contract information setting unit that sets contract information indicating the one or more inspections that the user terminal requires, wherein
the route setting unit decides the transfer route on the basis of the contract information that is set.

14. The information processing apparatus according to claim 12, further comprising:
a routing table where a next transfer destination of the data is stored, wherein
the inspection container further includes a container routing table where a next transfer destination of the data is stored; and
the route setting unit sets the transfer route decided regarding the user terminal in the routing table and the container routing table.

15. A method for causing a computer, which is provided with a plurality of containers that are virtual terminals of which resources including a file system provided by an operating system of the computer are isolated from each other, and which executes inspection regarding one or more security inspection items, to execute:
acquiring data flowing over a network before the data reaches a destination;
transmitting the data to the destination; and
executing the inspection regarding the data that has been acquired, in an inspection container, which is part of the plurality of containers, where an application for executing the inspection has been implemented.

16. A computer-readable non-transitory medium on which is recorded a program causing a computer, which is provided with a plurality of containers that are virtual terminals of which resources including a file system provided by an operating system of the computer are isolated from each other, and which executes inspection regarding one or more security inspection items, to function as:
a data acquisition unit that acquires data flowing over a network before the data reaches a destination;
a data transmission unit that transmits the data to the destination; and
a inspection unit that executes the inspection regarding the data that has been acquired, in an inspection container, which is part of the plurality of containers, where an application for executing the inspection has been implemented.
